(19) United States
(12) Patent Application Publication
(10) Pub. No.: US 2023/0091127 A1
(43) Pub. Date: Mar. 23, 2023

(54) WIRELESS NETWORK CONTROL BASED ON ROAMING QUALITY ASSESSMENTS

(71) Applicant: Juniper Networks, Inc., Sunnyvale, CA (US)

(72) Inventors: May Zar Lin, San Jose, CA (US); Wenfeng Wang, Cupertino, CA (US); Jacob Thomas, Saratoga, CA (US)

(21) Appl. No.: 17/931,708

(22) Filed: Sep. 13, 2022

Related U.S. Application Data
(60) Provisional application No. 63/268,968, filed on Mar. 7, 2022.
(60) Provisional application No. 63/243,414, filed on Sep. 13, 2021.

(51) Int. Cl. H04W 8/02; H04B 17/318

(52) U.S. Cl. CPC H04W 8/02; H04B 17/318

(57) ABSTRACT

Techniques are described by which a network management system (NMS) is configured to monitor and/or control a wireless network based on one or more roaming quality assessments. The NMS determines one or more roaming quality assessments for each roaming event and/or each network device in the wireless network. The roaming quality assessments include one or more of a roaming latency score, a signal quality score and/or a stability score. The roaming quality assessments may further include one or more suboptimal roam scores, sticky client scores, and/or interband scores. The NMS may further detect one or more ping-pong roaming events or excessive roaming events.

### CROSS-REFERENCE TO RELATED APPLICATIONS

This application claims the benefit of U.S. Provisional Application 63/243,414, filed Sep. 13, 2021, and claims the benefit of U.S. Provisional Application 63/268,968, filed Mar. 7, 2022, each of which is incorporated by reference herein in its entirety.

### FIELD

The disclosure relates generally to computer networks and, more specifically, to monitoring and control of wireless network performance.

### BACKGROUND

Commercial premises, such as offices, hospitals, airports, stadiums, or retail outlets, often install complex wireless network systems, including a network of wireless access points (APs), throughout the premises to provide wireless network services to one or more wireless client devices (or simply, “clients”). APs are physical, electronic devices that enable other devices to wirelessly connect to a wired network using various wireless networking protocols and technologies, such as wireless local area networking protocols conforming to one or more of the IEEE 802.11 standards (i.e., “Wi-Fi”), Bluetooth/Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network. As the client devices move throughout the premises, they may automatically switch or “roam” from one wireless access point to another, in-range wireless access point, so as to provide the users with seamless network connectivity throughout the premises.

### SUMMARY

In general, this disclosure describes techniques for monitoring and/or control of a wireless network based on one or more roaming quality assessments. A network management system (NMS) receives network data associated with a plurality of client devices associated with a wireless network. The network data is indicative of one or more aspects of wireless network performance. The NMS determines one or more roaming quality assessments for each of a plurality of roaming events and/or of the plurality of client devices based on the network data. The roaming quality assessments may include a sticky client score, a suboptimal roam score, and/or an interband score. The NMS may further detect ping-pong and/or excessive roaming events for one or more client devices.

Based on the roaming quality assessments, the NMS may determine a roaming metric for the wireless network. The NMS may further identify anomalies in roaming performance of the wireless network, identify a root cause of one or more anomalies in the roaming performance of the wireless network, and/or automatically invoke one or more remedial actions to address the identified anomalies.

The techniques of the disclosure provide one or more technical advantages and practical applications. The techniques enable the NMS to automatically monitor and quantify roaming quality, which considers factors other than or in addition to roaming latency (e.g., the amount of time required for a client device to roam from a first AP to a second AP). For example, while roaming latency is a time-based metric, the techniques of the disclosure enable the NMS to consider RSSI measurements of wireless signal strength before and/or after a roaming event when evaluating roaming performance of a wireless network and/or configuring operation of one or more devices in the wireless network (such as one or more APs in the wireless network) to address poor roaming performance. In other examples, the techniques enable the NMS to consider the number of roaming options available during each roaming event and/or the types of roaming options available during each roaming event when evaluating performance of the wireless network and/or configuring operation of one or more devices in the wireless network to address poor roaming performance. In such examples, the techniques enable the NMS to proactively monitor and analyze roaming events based on one or more factors in addition to or as an alternative to time-based metrics such as roaming latency. The NMS may further detect ping-pong and/or excessive roaming events for one or more client devices. Based on the one or more of the roaming quality assessment(s), the NMS may further determine a roaming metric indicative of overall roaming performance of the wireless network, identify anomalies in roaming performance of the wireless network, identify a root cause of one or more anomalies in the roaming performance of the wireless network, and/or automatically invoke one or more remedial actions to address the identified anomalies. In this way, the techniques of the disclosure may enhance performance of the wireless network from the perspective of the client devices, thus enhance the user experience of the wireless network.

In one example, the disclosure is directed to a system comprising a plurality of access point (AP) devices configured to provide a wireless network at a site; and a network management system comprising: a memory storing network data received from the plurality of AP devices, the network data collected by a plurality of client devices associated with the wireless network or the plurality of AP devices; and one or more processors coupled to the memory and configured to determine, based on the network data, one or more roaming quality assessments for each of a plurality of roaming events in the wireless network, wherein the one or more roaming quality assessments include a suboptimal roam score for each of the plurality of roaming events based on a received signal strength indicator (RSSI) associated with the roaming event.

In another example, the disclosure is directed to a method comprising receiving, by one or more processors of a network management system that manages a plurality of access point (AP) devices associated with a wireless network, network data indicative of performance of the wireless network, the network data collected by a plurality of client devices associated with the wireless network or the plurality of AP devices; and determining, based on the network data, one or more roaming quality assessments for each of a plurality of roaming events in the wireless network, wherein the one or more roaming quality assessments include a suboptimal roam score for each of the plurality of roaming events based on a received signal strength indicator (RSSI) associated with the roaming event.

In another example, the disclosure is directed to a non-transitory computer-readable storage medium comprising instructions that, when executed, configure processing circuitry to receive network data indicative of performance of a wireless network, the network data collected by a plurality of client devices associated with the wireless network or a plurality of access point (AP) devices associated with the wireless network; and determine, based on the network data, one or more roaming quality assessments for the wireless network, wherein the one or more roaming quality assessments include a suboptimal roam score for each of the plurality of roaming events based on a received signal strength indicator (RSSI) associated with the roaming event.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram of an example network system in which a network management system (NMS) is configured to monitor and/or control one or more wireless networks based on one or more roaming quality assessments in accordance with one or more techniques of the disclosure.

FIG. 2 is a block diagram of an example access point device in accordance with one or more techniques of the disclosure.

FIGS. 3A and 3B are a block diagrams of an example network management system configured to monitor and/or control one or more wireless networks based on one or more roaming quality assessments in accordance with one or more techniques of the disclosure.

FIG. 4 is a block diagram of an example user equipment device in accordance with one or more techniques of the disclosure.

FIG. 5 is a block diagram of an example network node, such as a router or switch, in accordance with one or more techniques of the disclosure.

FIG. 6A-6C are graphs showing example roaming latency scores in accordance with one or more techniques of the disclosure.

FIG. 7A is a graph showing suboptimal roam scores for a plurality of roaming events in a wireless network in accordance with one or more techniques of the disclosure.

FIG. 7B shows two scatter plots of interband scores for a plurality of interband roaming events in accordance with one or more techniques of the disclosure.

FIG. 8 is a flowchart of an example process by which a network management system determines a roaming metric in accordance with one or more techniques of the disclosure.

FIG. 9 is a flowchart of an example process by which a network management system determines a sticky client score for a client device in a wireless network in accordance with one or more techniques of the disclosure.

FIG. 10 is a flowchart of an example process by which a network management system determines whether one or more roaming quality assessment(s) for a wireless network represent anomalous operation of the wireless network in accordance with one or more techniques of the disclosure.

FIGS. 11A-11H are screenshots of example user interfaces that may be displayed in accordance with one or more techniques of the disclosure.

FIGS. 12A-12D illustrate example ping-pong roaming events that may be detected by a network management system in accordance with one or more techniques of the disclosure.

FIGS. 12E-12F illustrate example an excessive roaming event that may be detected by a network management system in accordance with one or more techniques of the disclosure.

FIGS. 13A-13B are flowcharts of example processes by which a network management system detects a ping-pong roaming event or an excessive roaming event, respectively, in accordance with one or more techniques of the disclosure.

FIG. 14 shows an example user interface including data indicative of one or more ping-pong roaming events or one or more excessive roaming events detected for a client device, in accordance with one or more techniques of the disclosure.

### DETAILED DESCRIPTION

Commercial premises, such as offices, hospitals, airports, stadiums, or retail outlets, often install complex wireless network systems, including a network of wireless access points (APs), throughout the premises to provide wireless network services to one or more wireless client devices. The client devices may include, for example, smart phones or other mobile computing devices, Internet of Things (IoT) devices, etc. Roaming in a wireless network occurs when a wireless client device disassociates itself from one AP and establishes an association with a different AP so as to provide the client devices with seamless network connectivity throughout the premises. While roaming to a new AP may increase the wireless signal power received by the client device, the roaming transition between APs consumes time and resources and as such has an adverse impact on the performance of the communication. To minimize these adverse transition affects, client devices often employ a fixed roaming threshold. For example, a client device may be configured to seek potential roaming candidates only if the signal from the currently associated AP is lower than a fixed roaming threshold, e.g., −72 dBm (decibels milliwatt). In addition, the RSSI of the new wireless signal must be better than the RSSI of the current wireless signal in order for a roam to take place.

A wireless network service provider may collect network data to monitor wireless network behavior and measure one or more aspects of wireless network performance at a site. The network data may be collected from, for example, one or more of client devices and/or one or more APs associated with the wireless network. One or more service level experience (SLE) metrics determined based on the collected network data can be used to measure various aspects of wireless network performance. SLE metrics seek to measure and understand network performance from the viewpoint of the end user experience on the network. One example SLE metric is a coverage metric, which tracks the number of user minutes that a client device's received signal strength indicator (RSSI) as measured by an access point with which the client is associated is below a configurable threshold. Another example SLE metric is a roaming metric, which tracks a client's percentage of successful roams between two access points that are within prescribed latency (e.g., time-based) threshold. Other example SLE metrics may include time to connect, throughput, successful connects, capacity, AP health, and/or any other metric that may be indicative of one or more aspects of wireless network performance. The SLE metrics may also include parameters such as a received signal strength indicator (RSSI) of a received wireless signal as measured by the client device, etc. The thresholds may be customized and configured by the wireless network service provider to define service level expectations at the site. The network service provider may further implement systems that automatically identify the root cause(s) of any SLE metrics that do not satisfy the thresholds, and/or that automatically implement one or more remedial actions to address the root cause, thus automatically improving wireless network performance.

In accordance with one or more techniques of the disclosure, a network management system (NMS) monitors and/or controls a wireless network based on one or more roaming quality assessments. The NMS receives network data associated with a plurality of client devices associated with a wireless network. The network data is indicative of one or more aspects of wireless network performance. The NMS determines one or more roaming quality assessments for each roaming event based on the network data.

The roaming quality assessments may include, for each roaming event and/or client device in the wireless network, a suboptimal roam score, a sticky client score, and/or an interband score. The NMS may further detect ping-pong and/or excessive roaming events for one or more client devices.

In some examples, to determine a suboptimal roam score for each roaming event, the NMS determines the current RSSI of a wireless signal received by the client device from a currently associated AP (i.e., the re-associated AP that was roamed to). In other examples, the NMS determines a difference (otherwise referred to as a delta) between a first RSSI of a first wireless signal received by a client device from a previously associated access point (AP) (i.e., the disassociated AP that was roamed away from) and a second RSSI of a second wireless signal received by the client device from a currently associated AP (i.e., the re-associated AP that was roamed to). For each roaming event, the NMS assigns a suboptimal roam score based on the RSSI of the client device upon completion of the roaming event. In some examples, the NMS assigns a suboptimal roam score based on an RSSI delta associated with the roaming event. To determine a sticky client score for a client device, the NMS assigns a sticky client score based on a number of roaming options available during each roaming event and/or the type of roaming options available during each roaming event. To determine an interband score for a client device, the NMS assigns an interband score based on an RSSI delta (i.e., change or difference in the RSSI) of the received wireless signal before and after an interband roaming event). In some examples, the NMS further detects ping-pong and/or excessive roaming events for one or more client devices, as described herein below.

The NMS may further determine one or more statistics based on the roaming quality assessments for a plurality of roaming events in a wireless network. For example, the NMS may determine a percentage of roaming events and/or client devices that were assigned each possible suboptimal roam score, each possible sticky client score and/or each possible interband score over one or more defined time periods. The NMS may further combine one or more of the roaming quality assessment(s) (e.g., the suboptimal roam score, the sticky client score, and/or the interband score), and/or detection of ping-pong or excessive roaming behavior with one or more roaming latency scores to determine a roaming metric indicative of overall roaming performance of the wireless network.

Based on the roaming quality assessments, and/or detection of the ping-pong and/or excessive roaming behavior for one or more client devices, the NMS may determine a roaming metric for the wireless network. Based on the roaming quality assessment(s) and/or detection of ping-pong and/or excessive roaming events for one or more client devices, the NMS may further identify anomalies in the roaming performance of the wireless network, identify a root cause of one or more anomalies in the roaming performance of the wireless network, and/or automatically invoke one or more remedial actions to address the identified anomalies.

The techniques of the disclosure provide one or more technical advantages and practical applications. The techniques enable the NMS to automatically monitor and quantify roaming quality, which considers factors other than or in addition to roaming latency (e.g., the amount of time required for a client device to roam from a first AP to a second AP). For example, while roaming latency is a time-based metric, the techniques of the disclosure enable the NMS to consider RSSI measurements of wireless signal strength before and after a roaming event when evaluating roaming performance of a wireless network and/or configuring operation of one or more devices in the wireless network (such as one or more APs in the wireless network) to address poor roaming performance. In other examples, the techniques enable the NMS to consider the number of roaming options available during each roaming event and/or the types of roaming options available during each roaming event when evaluating performance of the wireless network and/or configuring operation of one or more devices in the wireless network to address poor roaming performance. In this way, the techniques enable the NMS to proactively monitor and analyze roaming events based on one or more factors in addition to or as an alternative to time-based metrics such as roaming latency. The NMS may further detect ping-pong and/or excessive roaming events for one or more client devices. Based on the one or more of the roaming quality assessment(s), the NMS may further determine a roaming metric indicative of overall roaming performance of the wireless network, identify anomalies in roaming performance of the wireless network, identify a root cause of one or more anomalies in the roaming performance of the wireless network, and/or automatically invoke one or more remedial actions to address the identified anomalies. In this way, the performance of the wireless network from the perspective of the client devices, and thus the user experience of the wireless network, may be increased.

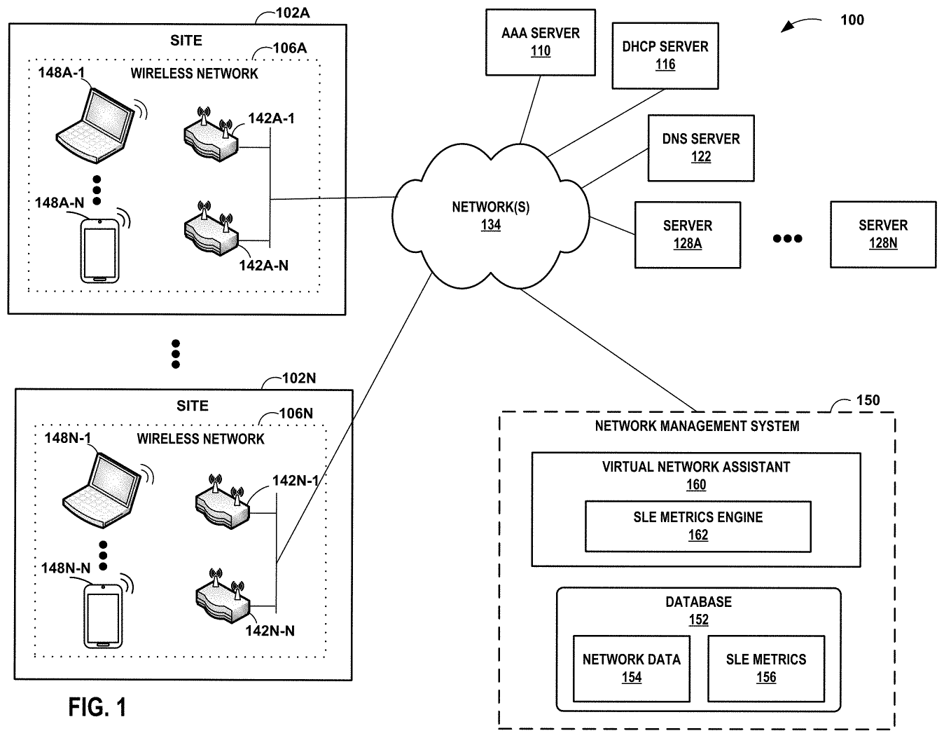

FIG. 1 is a diagram of an example network system 100 in which techniques for monitoring and/or control of a wireless network based on one or more roaming quality assessments are implemented. Example network system 100 includes a plurality sites 102A-102N at which a network service provider manages one or more wireless networks 106A-106N, respectively. Although in FIG. 1 each site 102A-102N is shown as including a single wireless network 106A-106N, respectively, in some examples, each site 102A-102N may include multiple wireless networks, and the disclosure is not limited in this respect.

Each site 102A-102N includes a plurality of access points (APs), referred to generally as APs 142. For example, site 102A includes a plurality of APs 142A-1 through 142A-N. Similarly, site 102N includes a plurality of APs 142N-1 through 142N-N. Each AP 142 may be any type of wireless access point, including, but not limited to, a commercial or enterprise AP, a router, or any other device capable of providing wireless network access.

Each site 102A-102N also includes a plurality of client devices, otherwise known as user equipment devices (UEs), referred to generally as UEs 148, representing various wireless-enabled devices within each site. For example, a plurality of UEs 148A-1 through148A-N are currently located at site 102A. Similarly, a plurality of UEs 148N-1 through 148N-N are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring or other wearable device. UEs 148 may also include IoT client devices such as printers, security devices, environmental sensors, or any other device configured to communicate over one or more wireless networks.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128 (e.g., web servers, databases servers, file servers and the like), and a network management system (NMS) 150. As shown in FIG. 1, the various devices and systems of network 100 are coupled together via one or more network(s) 134, e.g., the Internet and/or an enterprise intranet. Each one of the servers 110, 116, 122 and/or 128, APs 142, UEs 148, NMS 150, and any other servers or devices attached to or forming part of network system 100 may include a system log or an error log module wherein each one of these devices records the status of the device including normal operational status and error conditions.

In the example of FIG. 1, NMS 150 is a cloud-based computing platform that manages wireless networks 106A-106N at one or more of sites 102A-102N. As further described herein, NMS 150 provides an integrated suite of wireless network management tools and implements various techniques of the disclosure.

In accordance with the techniques described herein, NMS 150 monitors network data associated with wireless networks 106A-106N at each site 102A-102N, respectively, and manages network resources, such as APs 142 at each site, to deliver a high-quality wireless network experience to end users, IoT devices and clients at the site. The network data 154 may be stored in a database associated with NMS 150, such as database 152. In general, NMS 150 may provide a cloud-based platform for network data acquisition, monitoring, activity logging, reporting, predictive analytics, network anomaly identification, and alert generation.

For example, NMS 150 may include a virtual network assistant (VNA) 160 that analyzes network data received from one or more UEs 148 and/or one or more APs 142 in a wireless network, provides real-time insights and simplified troubleshooting for IT operations, and automatically takes remedial action or provides recommendations to proactively address wireless network issues. VNA 160 may, for example, include a network data processing platform configured to process hundreds or thousands of concurrent streams of network data from UEs 148, sensors and/or agents associated with APs 142 and/or nodes within network 134. For example, VNA 160 of NMS 150 may include a network performance engine that automatically determines one or more SLE metrics for each client device 148 in a wireless network 106. VNA 160 may also include an underlying analytics and network error identification engine and alerting system. VNA 160 may further provide real-time alerting and reporting to notify administrators or IT personnel of any predicted events, anomalies, trends, and may perform root cause analysis and automated or assisted error remediation.

In some examples, VNA 160 of NMS 150 may apply machine learning techniques to identify the root cause of error conditions or poor wireless network performance metrics detected or predicted from the streams of event data. VNA 160 may generate a notification indicative of the root cause and/or one or more remedial or remedial actions that may be taken to address the root cause of the error conditions or poor wireless network performance metrics. In some examples, if the root cause may be automatically resolved, VNA 160 invokes one or more remedial or mitigating actions to address the root cause of the error condition or poor wireless network performance metrics, thus automatically improving the underlying wireless network performance metrics (e.g., one or more SLE metrics) and also automatically improving the user experience of the wireless network.

Example details of these and other operations implemented by the VNA 160 and/or NMS 150 are described in U.S. application Ser. No. 14/788,489, filed Jun. 30, 2015, and entitled “Monitoring Wireless Access Point Events,” U.S. application Ser. No. 16/835,757, filed Mar. 31, 2020, and entitled “Network System Fault Resolution Using a Machine Learning Model,” U.S. application Ser. No. 16/279,243, filed Feb. 19, 2019, and entitled “Systems and Methods for a Virtual Network Assistant,” U.S. application Ser. No. 16/237,677, filed Dec. 31, 2018, and entitled “Methods and Apparatus for Facilitating Fault Detection and/or Predictive Fault Detection,” U.S. application Ser. No. 16/251,942, filed Jan. 18, 2019, and entitled “Method for Spatio-Temporal Modeling,” U.S. application Ser. No. 16/296,902, filed Mar. 8, 2019, and entitled “Method for Conveying AP Error Codes Over BLE Advertisements,” and U.S. application Ser. No. 17/303,222, filed May 24, 2021, and entitled, “Virtual Network Assistant Having Proactive Analytics and Correlation Engine Using Unsupervised ML Model,” all of which are incorporated herein by reference in their entirety.

In operation, NMS 150 observes, collects and/or receives network data 154. The network data is indicative of one or more aspects of wireless network performance. Network data 154 may take the form of data extracted from messages, counters and statistics, for example. The network data may be collected and/or measured by one or more UEs 148 and/or one or more APs 142 in a wireless network 106. Some of the network data 154 may be collected and/or measured by other devices in the network system 100. In accordance with one specific implementation, a computing device is part of the network management server 150. In accordance with other implementations, NMS 150 may comprise one or more computing devices, dedicated servers, virtual machines, containers, services or other forms of environments for performing the techniques described herein. Similarly, computational resources and components implementing VNA 160 may be part of the NMS 150, may execute on other servers or execution environments, or may be distributed to nodes within network 134 (e.g., routers, switches, controllers, gateways and the like).

In accordance with one or more techniques of the disclosure, NMS 150 monitors and/or controls a wireless network (such as any of wireless networks 106A-106N) based on one or more roaming quality assessments. For purposes of the disclosure, a roaming event occurs when a UE 148 disassociates from a first AP and re-associates with a second AP in the wireless network. NMS 150 receives network data (e.g., network data 154) associated with a plurality of client devices (e.g., UEs 148) associated with a wireless network (e.g., any of wireless networks 106a-106N). The network data is indicative of one or more aspects of wireless network performance.

NMS 150 determines one or more roaming quality assessments for each roaming event based on the network data. The roaming quality assessments may include, for each roaming event and/or client device in the wireless network, a suboptimal roam score, a sticky client score, and/or an interband score. In some examples, to determine a suboptimal roam score for each roaming event, the NMS 150 determines the current RSSI of a wireless signal received by the client device from a currently associated AP (i.e., the re-associated AP that was roamed to). In other examples, NMS 150 determines a difference (otherwise referred to as a delta) between a first RSSI of a first wireless signal received by a client device from a previously associated access point (AP) (i.e., the disassociated AP that was roamed away from) and a second RSSI of a second wireless signal received by the client device from a currently associated AP (i.e., the re-associated AP that was roamed to). For each roaming event, NMS 150 assigns a suboptimal roam score based on the current RSSI (or the RSSI difference) associated with the roaming event. To determine a sticky client score for a client device, NMS 150 assigns a sticky client score based on a number of roaming options available during each roaming event and/or the type of roaming options available during each roaming event. To determine an interband score for a client device for each roaming event, the NMS assigns an interband score based on an RSSI delta (i.e., change or difference in the RSSI) of the received wireless signal before and after an interband roaming event). The NMS may also detect ping-pong and/or excessive roaming events for one or more client devices as described herein below.

NMS 150 may also determine a roaming latency score for each roaming event based on the network data. For example, NMS 150 may determine a roaming latency score for each roaming event based on the amount of time required for the client device to execute the roaming event; that is, the amount of time required to disassociate from the first AP and re-associate with the second AP. In some examples, the roaming latency score may also be based on the type of roaming event. The types of roaming events may include, for example, one or more of standard roam events, Opportunistic Key Caching (OKC) roam events, and/or IEEE Fast Transition (802.11r) roam events.

NMS 150 may further determine one or more statistics based on the roaming quality assessments for a plurality of roaming events in a wireless network. For example, NMS 150 may determine a percentage of roaming events that were assigned each possible suboptimal roam score and/or a percentage of client devices that were assigned each possible sticky client score over one or more defined time periods. NMS 150 may further combine one or more of the roaming quality assessment(s) (e.g., the suboptimal roam score, the sticky client score, and/or the interband score) with one or more roaming latency scores to determine a roaming metric indicative of overall roaming performance of the wireless network. NMS 150 may further determine one or more statistics based on detection of ping-pong and/or excessive roaming events for one or more client devices. Based on the roaming quality assessments and/or detection of ping-pong or excessive roaming events, NMS 150 may further identify anomalies in the roaming performance of the wireless network, identify a root cause of one or more anomalies in the roaming performance of the wireless network, and/or automatically invoke one or more remedial actions to address the identified anomalies.

In general, the roaming quality assessment scores may be quantified on a numerical scale such that the range of possible scores is meaningful and/or statistically significant. For example, the roaming latency score, suboptimal roam score, sticky client score, and/or interband score for each client device may be assigned based on a binary scale, such as “good” or “poor.” In other examples, the roaming latency score, suboptimal roam score, sticky client score, and/or the interband score may be quantified on a numerical scale such as:

1: Excellent

2: Good

3: Average

4: Poor

5: Worst

The roaming quality assessment scores may therefore be scored, quantified or classified in many different ways, and the disclosure is not limited in this respect.

The techniques of the disclosure provide one or more technical advantages and practical applications. The techniques enable the NMS 150 to automatically monitor and quantify roaming quality, which considers factors other than or in addition to roaming latency (e.g., the amount of time required for a client device to roam from a first AP to a second AP). For example, while roaming latency is a time-based metric, the techniques of the disclosure enable the NMS 150 to consider RSSI measurements of wireless signal strength before and after a roaming event when evaluating roaming performance of a wireless network and/or configuring operation of one or more devices in the wireless network (such as one or more APs in the wireless network) to address poor roaming performance. In other examples, the techniques enable the NMS 150 to consider the number of roaming options available during each roaming event and/or the types of roaming options available during each roaming event when evaluating performance of the wireless network and/or configuring operation of one or more devices in the wireless network to address poor roaming performance. In this way, the techniques enable the NMS 150 to proactively monitor and analyze roaming events based on one or more factors in addition to or as an alternative to time-based metrics such as roaming latency. NMS 150 may further detect ping-pong and/or excessive roaming events for one or more client devices. Based on the one or more of the roaming quality assessment(s), the NMS 150 may further determine a roaming metric indicative of overall roaming performance of the wireless network, identify anomalies in roaming performance of the wireless network, identify a root cause of one or more anomalies in the roaming performance of the wireless network, and/or automatically invoke one or more remedial actions to address the identified anomalies. The remedial actions may include, for example, automatically reconfiguring operation of at least one of the plurality of AP devices 142 in the wireless network. In this way, the performance of the wireless network from the perspective of the client devices, and thus the user experience of the wireless network, may be increased.

Although the techniques of the present disclosure are described in this example as performed by NMS 150, it shall be understood that techniques described herein may be performed by any other computing device(s), system(s), and/or server(s), and that the disclosure is not limited in this respect. For example, one or more computing device(s) configured to execute the functionality of the techniques of the disclosure may reside in a dedicated server or be included in any other server (such as any of servers 128A-128N) in addition to or other than NMS 150, or may be distributed throughout network 100, and may or may not form a part of NMS 150.

In addition or alternatively, in some examples, network nodes (e.g., routers or switches within network 134) and/or access points 142 may be configured to locally determine one or more roaming quality assessments in a wireless network 106 at site 102, or to execute any of the functionality of the techniques described in the disclosure.

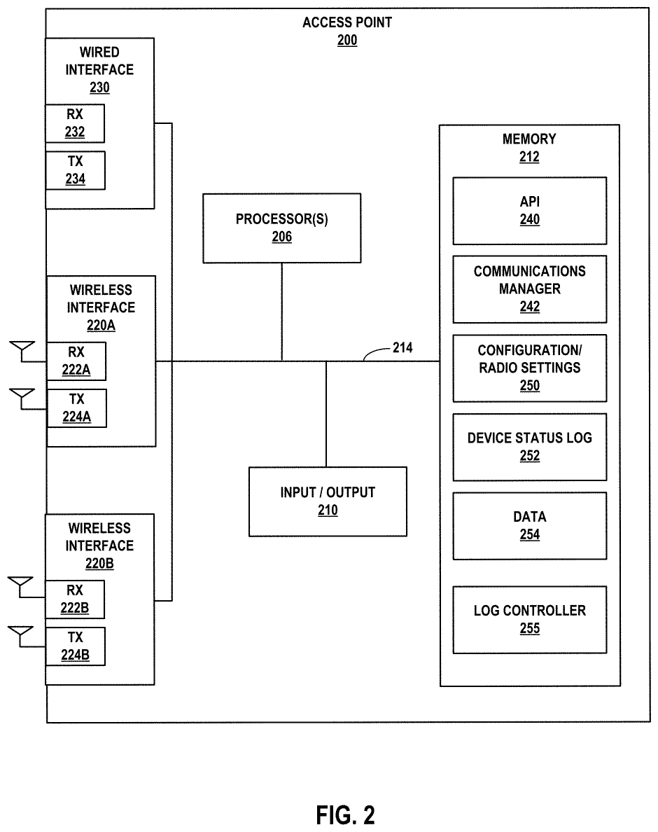

FIG. 2 is a block diagram of an example access point (AP) device 200 configured in accordance with one or more techniques of the disclosure. Example access point 200 shown in FIG. 2 may be used to implement any of APs 142 as shown and described herein with respect to FIG. 1. Access point 200 may comprise, for example, a Wi-Fi, Bluetooth and/or Bluetooth Low Energy (BLE) base station or any other type of wireless access point.

In the example of FIG. 2, access point 200 includes a wired interface 230, wireless interfaces 220A-220B, one or more processor(s) 206, memory 212, and a user interface 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to network(s) 134 of FIG. 1. First and second wireless interfaces 220A and 220B represent wireless network interfaces and include receivers 222A and 222B, respectively, each including a receive antenna via which access point 200 may receive wireless signals from wireless communications devices, such as UEs 148 of FIG. 1. First and second wireless interfaces 220A and 220B further include transmitters 224A and 224B, respectively, each including transmit antennas via which access point 200 may transmit wireless signals to wireless communications devices, such as UEs 148 of FIG. 1. In some examples, first wireless interface 220A may include a Wi-Fi 802.11 interface (e.g., 2.4 GHz and/or 5 GHz) and second wireless interface 220B may include a Bluetooth interface and/or a Bluetooth Low Energy (BLE) interface. However, these are given for example purposes only, and the disclosure is not limited in this respect.

Processor(s) 206 are programmable hardware-based processors configured to execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform one or more of the techniques described herein.

Memory 212 includes one or more devices configured to store programming modules and/or data associated with operation of access point 200. For example, memory 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 206 to perform one or more of the techniques described herein.

In this example, memory 212 stores executable software including an application programming interface (API) 240, a communications manager 242, configuration settings 250, a device status log 252 and data storage 254. Device status log 252 includes network data, e.g., a list of network parameters and/or network events, specific to AP 200 and/or client devices currently or previously associated with AP 200. The network data may include, for example, any network parameter and/or network data indicative of one or more aspects of performance of the wireless network or of the AP 200 itself In some examples, the network data may include a plurality of states measured periodically as time series data. The network data may be measured by the UE devices 148 and transmitted to AP 200, may be measured by AP 200 itself or by any other device associated with the wireless network and transmitted to AP 200.

Network data stored in data storage 254 may include, for example, AP events and/or UE events. In some examples, the network events are classified as positive network events, neutral network events, and/or negative network events. The network events may include, for example, memory status, reboot events, crash events, Ethernet port status, upgrade failure events, firmware upgrade events, configuration changes, authentication events, DNS events, DHCP events, one or more types of roaming events, etc., as well as a time and date stamp for each event. Log controller 255 determines a logging level for the device based on instructions from NMS 150. Data 254 may store any data used and/or generated by access point 200, including data collected from UEs 148, such as data used to calculate one or more SLE metrics, that is transmitted by access point 200 for cloud-based management of wireless networks 106A by NMS 150. For example, a UE 148 that executes a roaming event may measure or collect data concerning the number of available roaming options and/or the types of roaming options at the time of the roaming event, a first RSSI of a first wireless signal received from a first AP associated with the roaming event (e.g., the current AP or AP that was disassociated from) and a second RSSI of a second wireless signal received from a second AP associated with the roaming event (e.g., the target AP or AP that was re-associated to).

Based on the roaming event data in device status log 252 received from AP 200, a network management system (such as NMS 150 of FIG. 1) may identify each roaming event in a wireless network and may further determine when each roaming event occurred, the type of each roaming event, the roaming latency associated with each roaming event, and one or more roaming quality assessments for each roaming event. The roaming quality assessments may include a current RSSI upon completion of the roaming event, an RSSI delta associated with each roaming event, the number of available roaming options at the time of each roaming event and/or the types of available roaming options at the time of each roaming event. NMS 150 may further determine a suboptimal roaming score, a sticky client score, and/or an interband score. NMS 150 may further detect ping-pong and/or excessive roaming events for one or more client devices.

Communications manager 242 includes program code that, when executed by processor(s) 206, allow access point 200 to communicate with UEs 148 and/or network(s) 134 via any of interface(s) 230 and/or 220A-220B. Configuration settings 250 include any device settings for access point 200 such as radio settings for each of wireless interface(s) 220A-220B. These settings may be configured manually or may be remotely monitored and/or automatically managed or configured by NMS 150 to optimize wireless network performance on a periodic (e.g., hourly or daily) basis.

Input/output (I/O) 210 represents physical hardware components that enable interaction with a user, such as buttons, a touchscreen, a display and the like. Although not shown, memory 212 typically stores executable software for controlling a user interface with respect to input received via I/O 210.

In some examples, rather than the NMS 150 determining the one or more roaming quality assessments, AP 200 may be configured to determine the roaming quality assessments and/or automatically execute other functionality based on the roaming quality assessments.

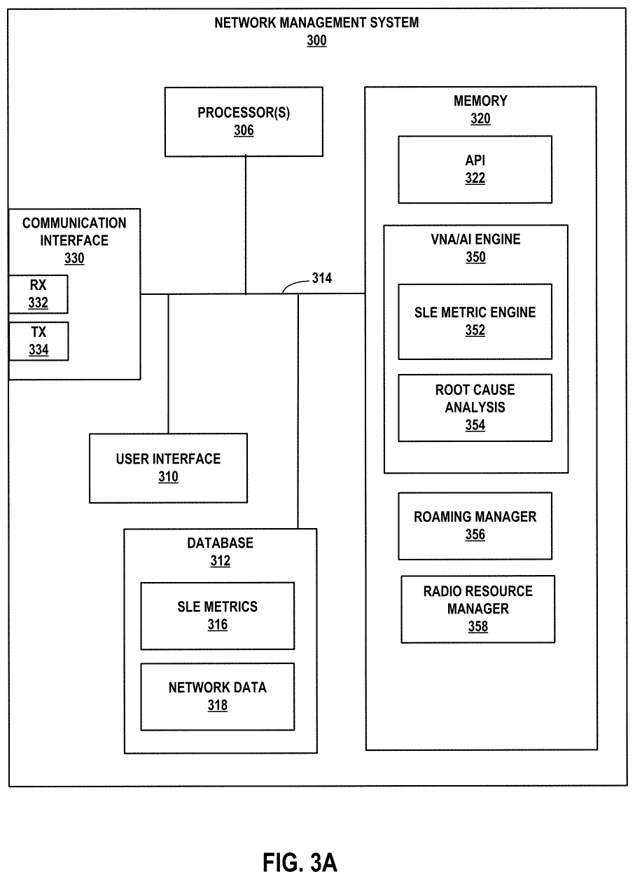

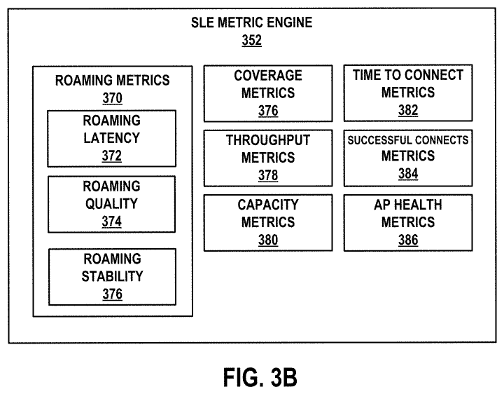

FIGS. 3A and 3B are a block diagrams of an example network management system (NMS) 300 configured to monitor and/or control one or more wireless networks based on one or more roaming quality assessments in accordance with one or more techniques of the disclosure. NMS 300 may be used to implement, for example, NMS 150 in FIG. 1. In such examples, NMS 300 is responsible for monitoring and management of one or more wireless networks 106A-106N at sites 102A-102N, respectively. In some examples, NMS 300 receives network data measured by network devices such as APs 200 and/or collected by APs 200 from UEs 148, such as network data used to determine one or more roaming quality assessments and analyzes this data for cloud-based management of wireless networks 106A-106N. In some examples, NMS 300 may be part of another server shown in FIG. 1 or a part of any other server.

NMS 300 includes a communications interface 330, one or more processor(s) 306, a user interface 310, a memory 320, and a database 312. The various elements are coupled together via a bus 314 over which the various elements may exchange data and information.

Processor(s) 306 execute software instructions, such as those used to define a software or computer program, stored to a computer-readable storage medium (such as memory 320), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1, and/or any local area networks. Communications interface 330 includes a receiver 332 and a transmitter 334 by which NMS 300 receives/transmits data and information to/from any of APs 142, servers 110, 116, 122, 128 and/or any other devices or systems forming part of network 100 such as shown in FIG. 1. The data and information received by NMS 300 may include, for example, network data and/or event log data received from access points 200 used by NMS 300 to remotely monitor and/or control the performance of wireless networks 106A-106N. NMS may further transmit data via communications interface 330 to any of network devices such as APs 142 at any of network sites 102A-102N to remotely manage wireless networks 106A-106N.

Memory 320 includes one or more devices configured to store programming modules and/or data associated with operation of NMS 300. For example, memory 320 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 320 includes an API 322, a virtual network assistant (VNA)/AI engine 350, a roaming manager 356, a radio resource management (RRM) engine 358, and a location engine 360. VNA engine 350 includes an SLE metric engine 352 and a root cause analysis engine 354. NMS 300 may also include any other programmed modules, software engines and/or interfaces configured for remote monitoring and management of wireless networks 106A-106N, including remote monitoring and management of any of APs 142/200.

NMS 300 also includes RRM engine 360 that monitors one or more metrics for each site 106A-106N in order to learn and optimize the RF environment at each site. For example, RRM engine 360 may monitor the coverage and capacity SLE metrics for a wireless network 106 at a site 102 in order to identify potential issues with coverage and/or capacity in the wireless network 106 and to adjust the radio settings of the access points at each site to address the identified issues. RRM engine 360 may determine channel and transmit power distribution across all APs 142 in each network 106A-106N. RRM engine 360 may monitor events, power, channel, bandwidth, and number of clients connected to each AP. RRM engine 360 may further automatically change or update configurations of one or more APs 142 at a site 106 with an aim to improve the coverage and/or capacity SLE metrics and thus to provide an improved wireless experience for the user.

VNA/AI engine 350 analyzes network data received from APs 142/200, and from other network devices as well as its own data to monitor performance of wireless networks 106A-106N. For example, VNA engine 350 may identify when anomalous or abnormal states are encountered in one of wireless networks 106A-106N. VNA/AI engine 350 may use root cause analysis module 354 to identify the root cause of any anomalous or abnormal states. In some examples, root cause analysis module 354 utilizes artificial intelligence-based techniques to help identify the root cause of any poor SLE metric(s) at one or more of wireless networks 106A-106N. In addition, VNA/AI engine 350 may automatically invoke one or more remedial actions intended to address the identified root cause(s) of one or more poor SLE metrics. Examples of remedial actions that may be automatically invoked by VNA/AI engine 350 may include, but are not limited to, invoking RRM 360 to reboot one or more APs and/or adjust/modify the transmit power of a specific radio in a specific AP, adding SSID configuration to a specific AP, changing channels on an AP or a set of APs, etc. The remedial actions may further include restarting a switch and/or a router, invoke downloading of new software to an AP, switch, or router, etc. These remedial actions are given for example purposes only, and the disclosure is not limited in this respect. If automatic remedial actions are not available or do not adequately resolve the root cause, VNA/AI engine 350 may proactively and automatically provide a notification including recommended remedial actions to be taken by IT personnel to address the anomalous or abnormal wireless network operation.

SLE metric engine 352 enables set up and tracking of thresholds for one or more SLE metrics for each of wireless networks 106A-106N. SLE metric engine 352 further analyzes network data (e.g., stored as network data 318) collected by APs and/or UEs associated with wireless networks 106A-106N, such as any of APs 142 from UEs 148 in each wireless network 106A-106N. For example, APs 142A-1 through 142A-N collect network data from UEs 148A-1 through 148A-N currently associated with wireless network 106A. This data, in addition to any network data collected by one or more APs 142A-1 through 142A-N in wireless network 106A, is transmitted to NMS 300 and stored as, for example, network data 318.

NMS 300 executes SLE metric engine 352 to determine one or more SLE metrics for each UE 148 associated with a wireless network 106. One or more of the SLE metrics may further be aggregated to each AP at a site to gain insight into each APs contribution to wireless network performance at the site. The SLE metrics track whether the service level for each particular SLE metric meets the configured threshold value(s). In some examples, each SLE metric may further include one or more classifiers. If a metric does not meet the configured SLE threshold value for the site, the failure may be attributed to one of the classifiers to further understand how and/or why the failure occurred.

Example SLE metrics and their classifiers that may be determined by NMS 300 are shown in Table 1.

TABLE 1

| | |
|---|---|
| Time to Connect | The number of connections that took longer than a specified threshold to connect |
| | to the internet. |
| | Classifiers: association, authorization, DHCP, internet services |
| Throughput | The amount of time, that a client's estimated throughput is below a specified |
| | threshold. |
| | Classifiers: capacity, coverage, device capability, network issues |
| Coverage | The number of user minutes that a client's RSSI as measured by the access point |
| | is below a specified threshold. |
| | Classifiers: asymmetry downlink, asymmetry uplink, Wi-Fi interference |
| Capacity | The number of user minutes that a client experiences “poor” capacity. |
| | Classifiers: AP load, non-Wi-Fi interference, Wi-Fi interference |
| Roaming | A measure of roaming performance based on the following Classifiers: |
| | Roaming Latency: scored based on the amount of time required for a client to |
| | successfully roam between 2 access points. |
| | Roaming Quality: based on suboptimal roam scores for each client |
| | device/roaming event, sticky client scores for each client device, and/or interband |
| | score for each client device/roaming event./ |
| | Roaming Stability: based on undesirable roaming events, such as fail to fast |
| | roams. |
| Successful Connects | The percentage of successful Authorization, Association, DHCP, ARP, and DNS |
| | attempts during an initial connection by a client to the network, when a client |
| | roams from one AP to the next, and on an on-going basis. |
| | Classifiers: association, authorization, DHCP |
| AP Health | This may be calculated based on AP Reboots, AP Unreachable events, and Site |
| | Down events. |
| | Classifiers: AP re-boot, AP Unreachable, Site Down |

A more detailed view of SLE metric engine 352 is shown in FIG. 3B. SLE metric engine 352 includes one or more modules for determining SLE and/or other network performance metrics, including a roaming metrics module 370, a coverage metric module 376, a throughput metric module 378, a capacity metric module 380, a time to connect module 382, a successful connects module 384 and an AP health module 386. SLE metric engine 352 may include some or all of these modules and may also include other modules for determination of other wireless network performance metrics.

In accordance with one or more techniques of the disclosure, roaming metrics module 370 includes a roaming latency module 372, roaming quality module 374, and roaming stability module 376. Roaming latency module 372, when executed by one or more processors such as processors 306 of FIG. 3A, determines and scores each roaming event based on the type of roam (e.g., standard roam, OKC roam, 802.11r roam, etc.) and the amount of time required for the client to successfully complete the roaming event.

Roaming quality module 374, when executed by one or more processors such as processors 306 of FIG. 3A, determines and scores one or more roaming quality assessments for each roaming event and/or client device. The roaming quality assessments may include, for example, a suboptimal roam score, a sticky client score, and/or an interband score. In some examples, to determine a suboptimal roam score for each roaming event, the suboptimal roam score is based on the current RSSI of a wireless signal received by the client device from a currently associated AP (i.e., the re-associated AP that was roamed to). In other examples, the suboptimal roam score is based on a RSSI delta defined as the difference between a first RSSI of a first wireless signal received by a client device from a first access point (AP) (i.e., the disassociated AP that was roamed away from) and a second RSSI of a second wireless signal received by the client device from a second AP (i.e., the re-associated AP that was roamed to). In some examples, for each roaming event, roaming quality module 374 assigns a suboptimal roam score based on the current RSSI of the wireless signal received by the client device upon completion of the roaming event. In some examples, roaming quality module 374 assigns a suboptimal roam score based on the RSSI delta of the current RSSI after completion of the roaming event as compared to the previous RSSI before occurrence of the roaming event. In addition, roaming quality module 374 assigns a sticky client score to a client device based on a number of roaming options available and/or the type of roaming options available during each roaming event. In addition, roaming quality module 374 assigns an interband score to a client device for each roaming event based on based on an RSSI delta (i.e., change or difference in the RSSI) of the received wireless signal before and after an interband roaming event). Roaming quality module 374 may further detect ping-pong and/or excessive roaming events for one or more client devices.

Roaming stability module 376, when executed by one or more processors such as processors 306 of FIG. 3A, determines and scores one or more roaming stability assessments for each roaming event and/or client device. The roaming stability assessments may include, for example, a fail to fast roam score. In general, the roaming stability assessment considers undesirable roaming events, such as fail to fast roams.

In some examples, the latency score for each roaming event, the suboptimal roam score for each roaming event, the sticky client score for each client device, and/or the interband score for each roaming event may be assigned based on empirical observations or measurements of wireless network behavior. In other examples, roaming latency module 372 and/or roaming quality module 274 may automatically generate and train one or more supervised and/or unsupervised machine learning (ML) models to assign a latency score, a suboptimal roam score, a sticky client score, an interband score, a roaming quality score and/or a roaming stability score to each roaming event and/or client device based on network data extracted from historically observed data and/or statistics for the wireless network.

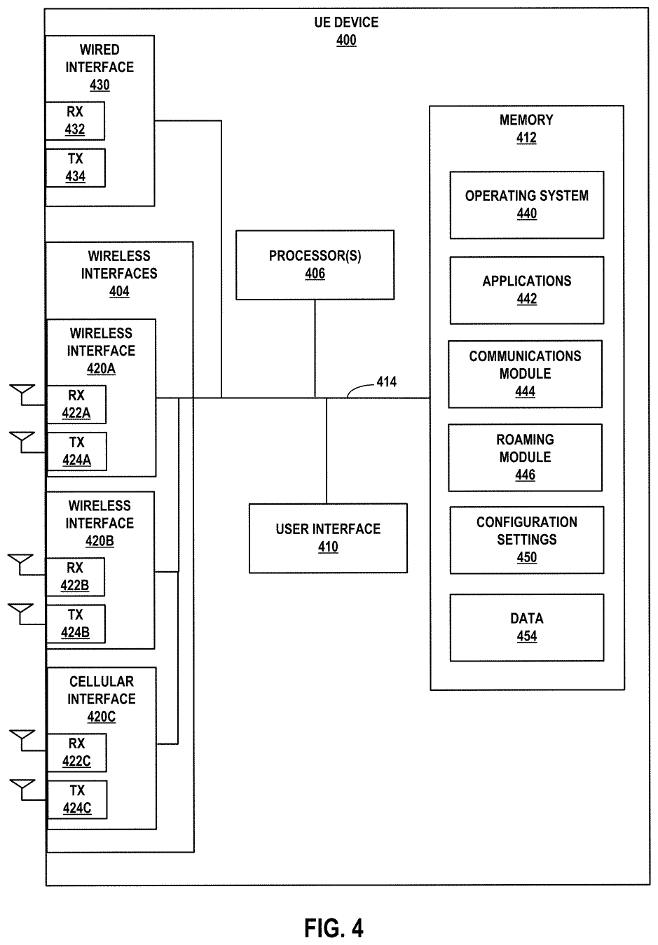

FIG. 4 shows an example user equipment (UE) device 400. Example UE device 400 shown in FIG. 4 may be used to implement any of UEs 148 as shown and described herein with respect to FIG. 1. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring or any other type of mobile or wearable device. UE 400 may also include any type of IoT client device such as a printer, a security sensor or device, an environmental sensor, or any other connected device configured to communicate over one or more wireless networks.

In accordance with one or more techniques of the disclosure, network data indicative of one or more aspects of the performance of a wireless network (that is, data used by NMS 150 to calculate one or more SLE metrics) is stored in UE memory 412 as network data 454 and transmitted to NMS 140/300 via one or more APs 142 in the wireless network. For example, NMS 150 receives network data from UEs 148 in networks 106A-106N of FIG. 1. In some examples, NMS 150 receives relevant network data from UEs 148 on a continuous basis (e.g., every 2 seconds or other appropriate time period), and NMS may calculate one or more SLE metrics for each UE on a periodic basis as defined by a first predetermined period of time (e.g., every 10 minutes or other predetermined time period).

The network data 454 may include, for example, RSSI measurements of one or more wireless signals received from one or more AP devices by UE 400 as measured by UE 400. The network data may further include a log of one or more UE associated events or states such as one or more roaming association events, re-association events, roam away events, disassociation events, association failure events, and any other data or event relevant for determination of one or more roaming quality assessments and/or other SLE metrics. Some of the specific messages associated with the roaming are 802.11 FT Auth Req, 802.11 FT Auth response, Re-association Req, Re-association Req Response, Action frame FT Req, FT frame Response, etc.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 includes a receiver 432 and a transmitter 434. Wired interface 430 may be used, if desired, to couple UE 400 to network(s) 134 of FIG. 1. First, second and third wireless interfaces 420A, 420B, and 420C include receivers 422A, 422B, and 422C, respectively, each including a receive antenna via which UE 400 may receive wireless signals from wireless communications devices, such as APs 142 of FIG. 1, AP 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as APs 142 of FIG. 1, AP 200 of FIG. 2, other UEs 138 and/or other devices configured for wireless communication. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming modules and/or data associated with operation of UE 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 includes an operating system 440, applications 442, a communications module 444, configuration settings 450, and data storage 454. Data storage 454 may include, for example, a status/error log including network data specific to UE 400. As described above, data 454 may include any network data, events, and/or states that may be related to determination of one or more roaming quality assessments. The network data may include event data such as a log of normal events and error events according to a logging level based on instructions from the network management system (e.g., NMS 150/300). Data storage 454 may store any data used and/or generated by UE 400, such as network data used to calculate one or more SLE metrics, that is collected by UE 400 and transmitted to any of APs 138 in a wireless network 106 for further transmission to NMS 150.

Communications module 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C. Roaming module 446 includes program code that, when executed by processor(s) 406, enable UE 400 to perform one or more roaming operations in a wireless network 106. For example, roaming module 446 includes program code that, when executed by processor(s) 406, enable UE 400 to, in response to determining that a measured roaming parameter(s) (such as an RSSI of a wireless signal received from a current AP, a number of failed connection attempts, etc.) is below a configured roaming threshold, seek for potential roaming candidates among other APs 148 in the wireless network 106. As another example, roaming module 446 includes program code that, when executed by processor(s) 406, enable UE 400 to, in response to receipt of a disassociation message from a current AP, seek for potential roaming candidates among other APs 148 in the wireless network 106.

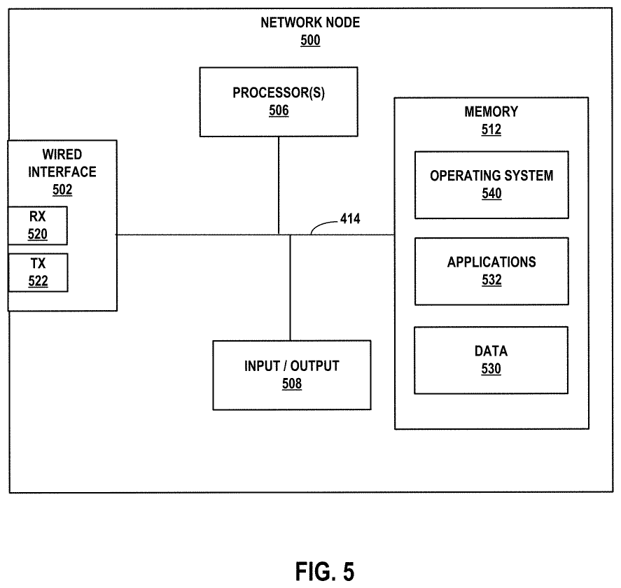

FIG. 5 is a block diagram illustrating an example network node 500 configured according to the techniques described herein. In one or more examples, the network node 500 implements a device or a server attached to the network 134 of FIG. 1, e.g., router, switch, AAA server, DHCP server, DNS server, VNA, Web server, etc., or a network device such as, e.g., routers, switches or the like. In some embodiments, network node 400 of FIG. 4 is server 110, 116, 122, 128, of FIG. 1 or routers/switches of network 134 of FIG. 1.

In this example, network node 500 includes a communications interface 502, e.g., an Ethernet interface, a processor 506, input/output 508, e.g., display, buttons, keyboard, keypad, touch screen, mouse, etc., a memory 512 and an assembly of components 516, e.g., assembly of hardware module, e.g., assembly of circuits, coupled together via a bus 509 over which the various elements may interchange data and information. Communications interface 502 couples the network node 500 to a network, such as an enterprise network.

Though only one interface is shown by way of example, those skilled in the art should recognize that network nodes may, and usually do, have multiple communication interfaces. Communications interface 502 includes a receiver 520 via which the network node 500, e.g., a server, can receive data and information, e.g., including operation related information, e.g., registration request, AAA services, DHCP requests, Simple Notification Service (SNS) look-ups, and Web page requests. Communications interface 502 includes a transmitter 522, via which the network node 500, e.g., a server, can send data and information, e.g., including configuration information, authentication information, web page data, etc.

Memory 512 stores executable software applications 532, operating system 540 and data/information 530. Data 530 includes system log and/or error log that stores network data and/or SLE metrics for node 500 and/or other devices, such as wireless access points, based on a logging level according to instructions from the network management system. Network node 500 may, in some examples, forward the network data and/or the SLE metrics to a network management system (e.g., NMS 150 of FIG. 1) for analysis as described herein.

Referring again to FIG. 1, a UE, for example UE 148A-1, moves around site 102A and thus moves around with respect to APs 142A-1 to 142A-N of wireless network 106A. To execute a roaming event, assume UE 148A-1 is associated with a first AP 142A-1 and that the fixed roaming threshold of UE 148A-1 is −65 dBm. When UE 148A-1 detects that the RSSI of the wireless signal received from first AP 142A-1 reaches −65 dBm, UE 148A-1 initiates a roaming operation by sending out probe packets to identify potential roaming candidate APs in wireless network 106A. Upon discovery of one or more potential roaming candidate APs, UE 630A disassociates from first AP 142A-1 and re-associates with one of the potential roaming candidate APs, for example, a second AP 142A-N based on one or more defined criteria.

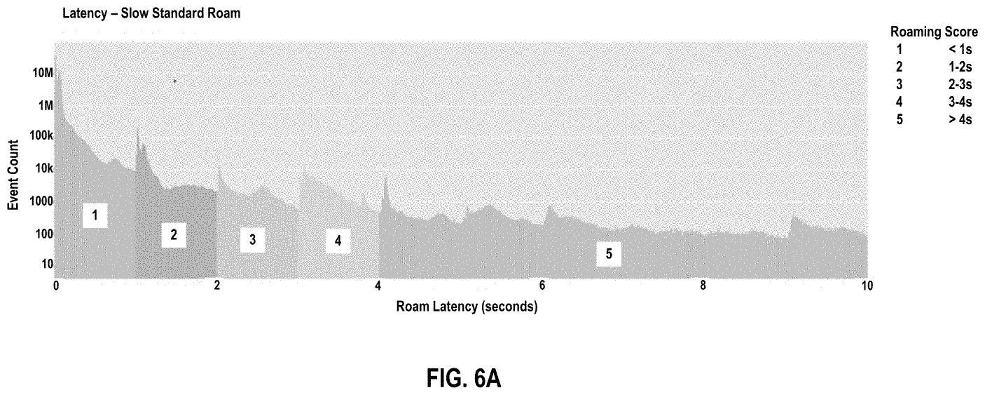

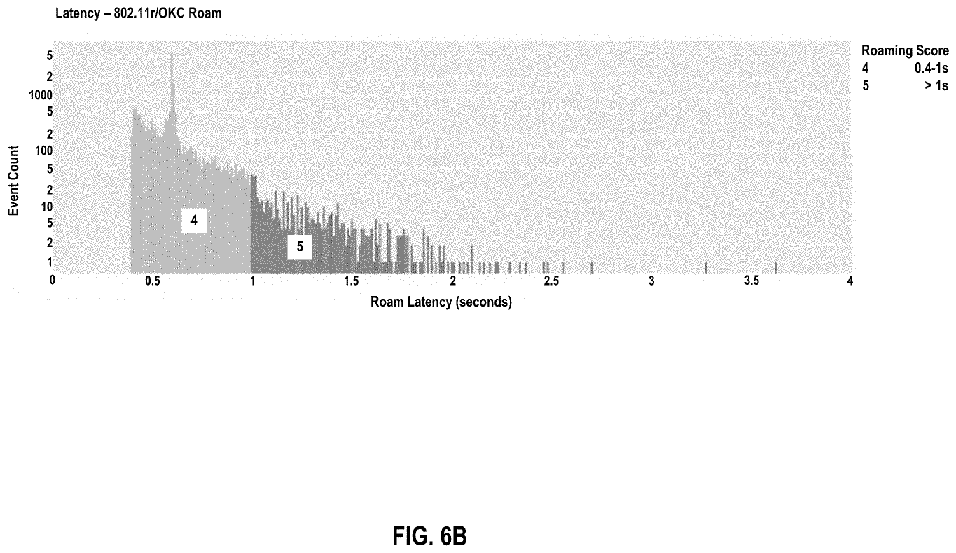

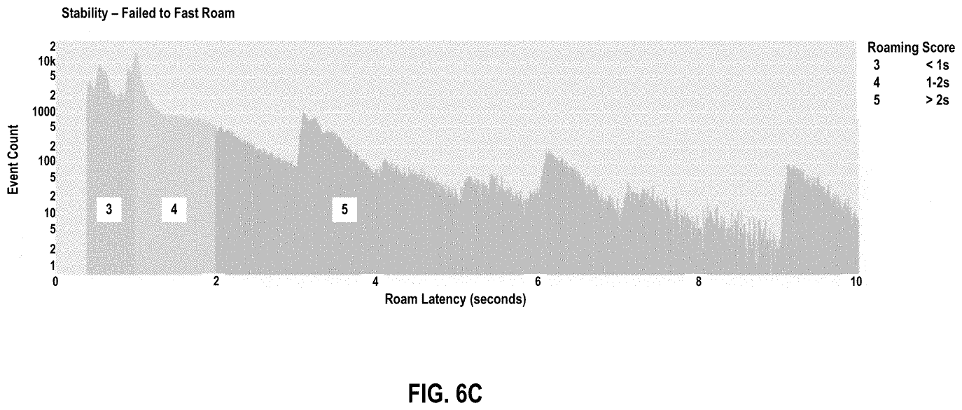

FIGS. 6A-6B are graphs showing example roaming latency scores for different types of roaming events in accordance with one or more techniques of the disclosure. To assign a roaming latency score for each roaming event, the roaming event is first categorized according to the type of roaming event. The types of roaming events may include, for example, standard (slow) roam events, OKC (fast) roam events, and 802.11r (fast) roam events. In some examples, OKC roam events and 802.11r roam events are categorized together in a single category as fast roam events.

FIG. 6A is a graph showing example roaming latency scores for a plurality of slow standard roaming events in accordance with one or more techniques of the disclosure. The graph shows the roaming latency (in seconds) versus an event count corresponding to the number of slow standard roaming events occurring within a predetermined time frame.

In the example of FIG. 6A, the roaming latency for each slow standard roaming event are assigned a roaming latency score from 1-5 where a roaming latency score of “1” is considered the highest or “Excellent” roaming latency score and a roaming latency score of “5” is considered the lowest or “Worst” roaming latency score. A roaming latency score of 1 (e.g., “excellent”) is assigned to roaming events of less than 1 second, a roaming latency score of 2 (e.g., “good”) is assigned to roaming events of between 1 and 2 seconds, a roaming latency score of 3 (e.g., “average”) is assigned to roaming events of between 2 and 3 seconds, a roaming latency score of 4 (e.g., “poor”) is assigned to roaming events of between 3 and 4 seconds, a roaming latency score of 5 (e.g., “worst”) is assigned to roaming events of greater than 4 seconds. The roaming events having latency scores of 3, 4, or 5 correspond to relatively longer roaming latencies, respectively, are more likely to be perceived by the user and thus represent progressively more severe impacts on the user experience of the wireless network.

In general, the roaming latency scores for slow standard roaming events are assigned based on their expected relative impact on the user experience of the wireless network. The thresholds for the score are determined based on what we believe that the system should be able to perform while using a specific roaming method. The number of roaming latency scores for slow standard roaming events may be determined to best represent the roaming behavior of client devices in the wireless network. The thresholds for assigning the roaming latency scores for slow standard roaming events may be determined based on empirical observations or measurements of roaming behavior or client devices in the wireless network. In addition, the thresholds may be dynamically updated based on analysis of roaming behavior in the wireless network over time and or based on the application running on the UE while the roaming process is ongoing. In other examples, NMS 150/300 may automatically generate and train one or more supervised and/or unsupervised machine learning (ML) models to assign a latency score to each slow standard roaming event based on historical network data and/or statistics for the wireless network. Thus, the number of latency scores, the thresholds for assigning a latency score to a slow standard roaming event, and/or the frequency at which the scores are updated, are not limited to the specific examples described herein, and the disclosure is not limited in this respect.

FIG. 6B is a graph showing example roaming latency scores for a plurality of “fast” roaming events (in this example, 802.11r and OKC roaming events) in accordance with one or more techniques of the disclosure. The graph shows the roaming latency (in seconds) versus an event count corresponding to the number of fast roaming events occurring within a predetermined time frame.

In the example of FIG. 6B, only roaming latency scores of 1 (e.g., “excellent”), 3 (e.g., “average”), 4 (e.g., “poor”) or 5 (e.g., “worst”) are assigned to the fast roaming events. A roaming latency score of 1 (e.g., “excellent”) is assigned to roaming events of less than about 300 milliseconds, roaming latency score of 3 (e.g., “average”) is assigned to roaming events of between about 300-400 milliseconds, a roaming latency score of 4 (e.g., “poor”) is assigned to roaming events of between about 400 milliseconds and 1 second, a roaming latency score of 5 (e.g., “worst”) is assigned to roaming events of greater than 1 second. The roaming events having latency scores of 3, 4, or 5 correspond to relatively longer roaming latencies, respectively, are more likely to be perceived by the user and thus represent progressively more severe impacts on the user experience of the wireless network. In the example of FIG. 6B, there were no average 802.11r/OKC roams so there are none appearing in the plot.

A roaming latency score is assigned to each fast roaming event. The roaming latency scores for fast roaming events are assigned based on relative expected distribution time for roaming using the roaming method. The number of roaming latency scores for fast roaming events may be determined to best represent the roaming behavior of client devices in the wireless network. The thresholds for assigning the roaming latency scores for fast roaming events may be determined based on empirical observations or measurements of roaming behavior or client devices in the wireless network. In addition, the thresholds may be dynamically updated based on analysis of roaming behavior in the wireless network over time. In other examples, NMS 150/300 may automatically generate and train one or more supervised and/or unsupervised machine learning (ML) models to assign a latency score to each fast roaming event based on historical network data and/or statistics for the wireless network. Thus, the number of latency scores, the thresholds for assigning each latency score to a fast roaming event, and/or the frequency at which the scores are updated, are not limited to the specific examples described herein, and the disclosure is not limited in this respect.

FIG. 6C is a graph showing example roaming latency scores for a plurality of slow standard roaming events in accordance with one or more techniques of the disclosure. The graph shows the roaming latency (in seconds) versus an event count corresponding to the number of slow standard roaming events occurring within a predetermined time frame.

In the case of failed to fast roam events such as those shown in the example of FIG. 6C, the fact that a failed to fast roam event occurred is generally an unsatisfactory result. That is, the wireless client device can perform a fast roam (e.g., fast roams are enabled for the client device) but for some reason performed a slow roam instead. In other words, in these examples, there are no “excellent” or “good” failed to fast roam events. The roaming latency for each failed to fast roam event are therefore assigned a roaming latency score from 3-5 where a roaming latency score of 3 (e.g., “average”) is assigned to roaming events of between 400 milliseconds and 1 second, a roaming latency score of 4 (e.g., “poor”) is assigned to roaming events of between 1 and 2 seconds, and a roaming latency score of 5 (e.g., “worst”) is assigned to roaming events of greater than 2 seconds.

A failed to fast roam event latency score is assigned to each failed to fast roaming event. In general, the roaming latency scores for failed to fast roam events are assigned based on based on relative expected distribution time for roaming using the roaming method. The number of roaming latency scores for failed to fast roam events may be determined to best represent the roaming behavior of client devices in the wireless network. The thresholds for assigning the roaming latency scores for failed to fast roam events may be determined based on empirical observations or measurements of roaming behavior or client devices in the wireless network. In addition, the thresholds may be dynamically updated based on analysis of roaming behavior in the wireless network over time. In other examples, NMS 150/300 may automatically generate and train one or more supervised and/or unsupervised machine learning (ML) models to assign a latency score to each failed to fast roam event based on historical network data and/or statistics for the wireless network. Thus, the number of latency scores, the thresholds for assigning each latency score to a failed to fast roaming event, and/or the frequency at which the scores are updated, are not limited to the specific examples described herein, and the disclosure is not limited in this respect.

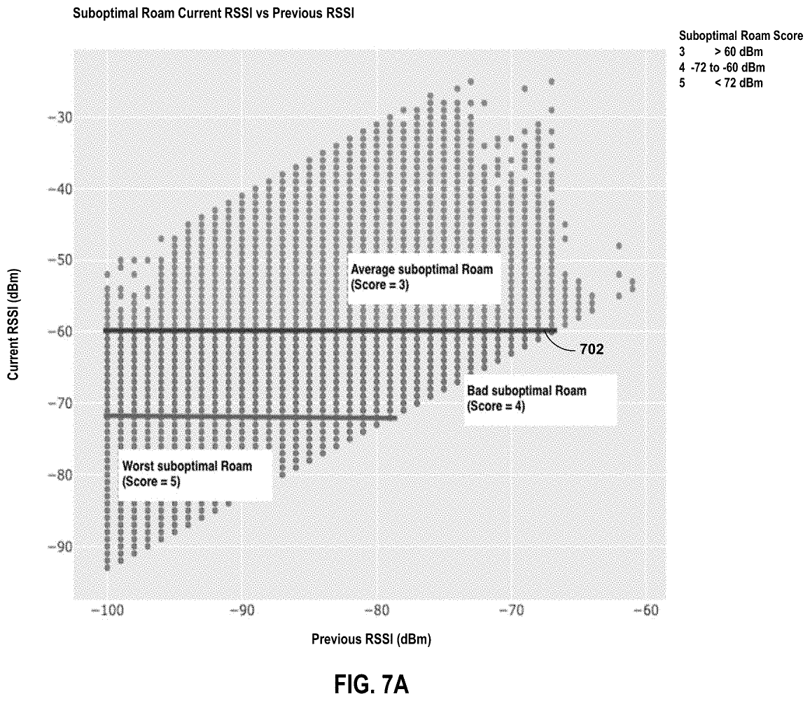

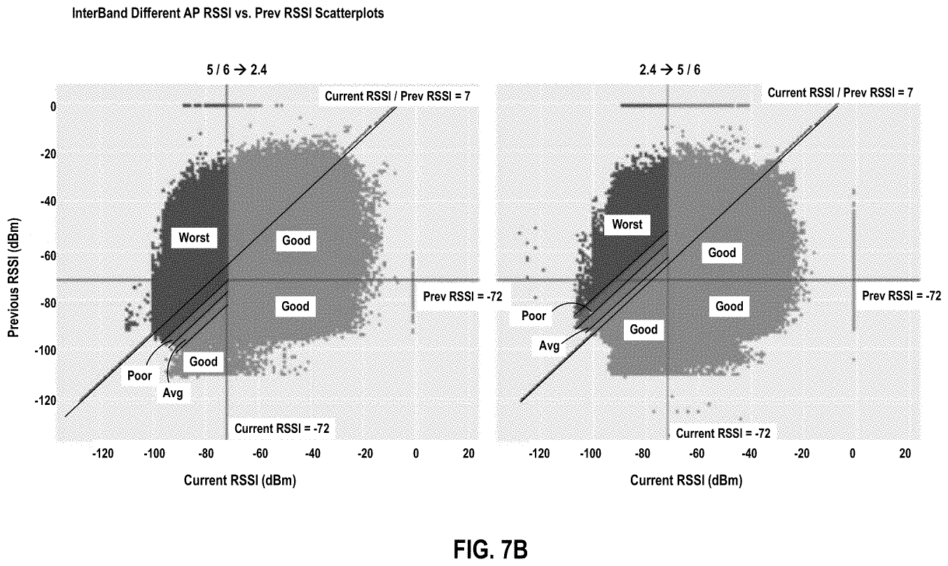

FIG. 7A is a graph showing suboptimal roam scores for a plurality of roaming events in a wireless network in accordance with one or more techniques of the disclosure. The x-axis represents a previous RSSI (as measured by the client device in decibel milliwatt (dBm)) of a first wireless signal received from a first AP with which the client device is associated at the start of a roaming operation (e.g., before the roam operation takes place). The y-axis represents the RSSI (as measured by the client device in decibel milliwatt (dBm)) of a second wireless signal received from a second AP with which the client device is associated after completion of the roaming operation.

In the example of FIG. 7A, the roaming events may be scored as shown in the following chart.

| Current RSSI | Suboptimal Roam Score |
|---|---|
| >60 dBm | 3-Good |
| −72 to −60 dBm | 4-Bad |
| <−72 | 5-Worst |

Any roaming event resulting in an RSSI above a predetermined threshold (−60 dBm in this example) is considered acceptable and is thus assigned a suboptimal roaming score of 3 (e.g., “average”). In other words, in these examples, there are no “excellent” or “good” suboptimal roam events. The suboptimal roaming scores for each roaming event are therefore assigned a suboptimal roam score from 3-5 where a score of 3 (e.g., “average”) is assigned to suboptimal roam events resulting in an RSSI above a threshold of about −60 dBm, a suboptimal roam score of 4 (e.g., “poor”) is assigned to roaming events resulting in an RSSI between about −72 and −60 dBm, and a suboptimal roam score of 5 (e.g., “worst”) is assigned to roaming events resulting in an RSSI of less than about −72 dBm. The roaming events having suboptimal roam scores of 3, 4, and 5 resulted in a relatively poor RSSI value, respectively, and represent progressively more severe impacts on the user experience of the wireless network.

A suboptimal roam score is calculated for each roaming event. In general, the suboptimal roam scores are assigned based on their relative impact on the user experience of the wireless network. The number of suboptimal roam scores may be determined to best represent the roaming behavior of client devices in the wireless network. The thresholds for assigning the suboptimal roam scores for each roaming event may be determined based on empirical observations or measurements of roaming behavior or client devices in the wireless network. In the example of FIG. 7A, the thresholds between suboptimal roaming scores are constant. However, in other examples, the boundaries need not be constant, and the disclosure is not limited in this respect. In addition, the thresholds may be dynamically updated based on analysis of roaming behavior in the wireless network over time. In other examples, NMS 150/300 may automatically generate and train one or more supervised and/or unsupervised machine learning (ML) models to assign a suboptimal roam score to each roaming event based on historical network data and/or statistics for the wireless network. Thus, the number of suboptimal roam scores, the thresholds for assigning a suboptimal roam score to a roaming event, and/or the frequency at which the suboptimal roam scores are updated, are not limited to the specific examples described herein, and the disclosure is not limited in this respect.

In accordance with one or more techniques of the disclosure, the one or more roaming assessments for a client device determined by NMS 150/300 may include a sticky client score. For purposes of the disclosure, a sticky client is defined as a client device having a current RSSI value of less than a fixed roaming threshold for the client device and having one or more roaming options at least 7 dBm better than the current RSSI value. NMS 150/300 may assign a sticky client score to a client device based on a number of available roaming options and/or the type of available roaming options for the client device. For example, NMS 150/300 may assign a sticky client score to a client device according to the following:

| Score | Description |
|---|---|
| 5 | One roaming option - same AP Different Band (Worst) |
| 4 | Multiple roaming options - Different APs Same/Different Band |
| | (client roaming decision issue, Poor) |
| 3 | One roaming option - Different AP Same/Different Band (client |
| | roaming decision issue, Average) |

In general, the sticky client scores are assigned based on the relative “stickiness” of the client device and are indicative of the relative severity of the impact of the failure to roam on the user experience of the wireless network. For the sticky client classifier, there are no good or excellent scores (e.g., a score of 1 or 2) because a sticky client is undesirable. For example, a sticky client score of “3” is assigned to a client device satisfying the sticky client criteria “different AP same/different band.” A sticky client score of “4” (multiple roaming options, different APs same/different band) is perceived to have a relative more severe impact on the user experience than a sticky client score of “3.” A sticky client score of “5” (same AP, different band) is perceived to have a relatively more severe impact on the user experience than a sticky client score of “4.” The situation in which a client device has only one roaming option of the same AP on a different band (e.g., roaming from 2.4 GHz to 5 GHz in the same AP or vice versa) could be an indication that there is a coverage hole in the wireless network at that location within the site. This situation is assigned a sticky client score of “5” because existence of coverage hole(s) is highly likely to lead to a poor user experience of the wireless network. Remedial actions to address a potential coverage hole include adding one or more additional APs to the wireless network and/or adjusting the transmit power balance among one or more of the APs in the wireless network.

In accordance with one or more techniques of the disclosure, the one or more roaming assessments for a wireless client device determined by NMS 150/300 may include an interband score. The interband score for each of the plurality of client devices is determined based on an RSSI delta (e.g., change or difference in the RSSI) associated with each of a plurality of interband roaming events for the client device.

For purposes of the disclosure, an interband roam is defined as a wireless client device roaming from a first AP at the 2.4 GHz band to a second AP at the 5 GHz (or 6 GHz) band, or conversely from a first AP at the 5 GHz (or 6 GHz) to a second AP at the 2.4 GHz band. An interband score is assigned to both of these types of interband roaming events.

In some examples, the thresholds for determining the interband score for a 2.4 to 5/6 GHz interband roaming event are different than the thresholds for determining the interband score for a 5/6 to 2.4 GHz roaming event. In examples where the 5/6 GHz bands are generally more preferable than the 2.4 GHz band (due to faster speeds), roams from 2.4 to 5/6 GHz are generally more preferred as compared to roams from 5/6 GHz to 2.4 GHz. In general, for each roaming event, a positive change (also referred to as the delta or A) in the RSSI indicates an improvement in the RSSI for the client device, while a negative change or delta in the RSSI indicates a deterioration in the RSSI for the client device. The thresholds indicate the RSSI delta at which the interband score is assigned as one of 1,2,—excellent/good, 3—average, 4—poor or 5—worst. Although particular example thresholds are described herein, other thresholds may also be used, and the disclosure is not limited in this respect. In addition, although the thresholds for the 5 and 6 GHz bands are the same in these examples, in other examples, there may be different thresholds for roaming to/from the 5 GHz band as compared to the thresholds for roaming to/from the 6 GHz band, and the disclosure is also not limited in this respect.

For example, NMS 150/300 may assign an interband score to a client device according to the following:

Different AP Interband Roam 5/6→2.4 GHz

| Score | Description |
|---|---|
| 5 | Worst - when client RSSI does not improve or decreases |
| | (RSSI delta <= 0) |
| 4 | Poor - when client RSSI improves but less than 5 dB |
| 3 | Average - when client RSSI improves more than 5 dB and less than |
| | 10 dB |
| 1, 2 | Good - when client RSSI improves more than 10 dB |

Different AP Interband Roam 2.4→5/6 GHz

| Score | Description |
|---|---|
| 5 | Worst - when client RSSI decreases more than 20 dB |
| 4 | Poor - when client RSSI decreases more than 15 dB and less than |
| | 20 dB |
| 3 | Average - when client RSSI decreases more dian 10 dB and less |
| | than 15 dB |
| 1, 2 | Good - when client RSSI decreases less than 10 dB or improves |

In some examples, where the interband roaming event is between bands at the same AP, the interband scores/thresholds are shifted down by one score value as follows:

Same AP Interband Roam 5/6→2.4 GHz

| Score | Description |
|---|---|
| 5 | Worst - when client RSSI improves but less than 5 dB or does |
| | not improve or decreases (RSSI delta <= 5dB) |
| 4 | Poor - when client RSSI improves more than 5 dB and less than |
| | 10 dB |

Same AP Interband Roam 2.4→5/6 GHz

| Score | Description |
|---|---|
| 5 | Worst - when client RSSI decreases more than 15 dB |
| 4 | Poor - w hen client RSSI decreases more than 10 dB and less than |
| | 15 dB |

In these examples, there are no average or good/excellent scores for same AP interband roam, as roaming between bands at the same AP is generally undesirable in these examples.

Although particular examples of interband roaming events, thresholds, and scores are described herein, different or alternative thresholds and/or scores may be assigned to one or more of types of interband roaming events, and the disclosure is not limited in this respect. For example, although the 5 and 6 GHz bands are shown as having the same thresholds/scores, different thresholds and/or scores may be assigned to roaming events to/from the 2.4 GHz band to/from the 5 GHz band as compared to roaming events to/from the 2.4 GHz band to/from the 6 GHz band, or to/from the 5 GHz band to/from the 6 GHz band, and the disclosure is not limited in this respect.

FIG. 7B shows scatterplots of example interband scores for a plurality of interband roaming events. The left side of FIG. 7B is a scatter plot of example interband scores for a plurality of interband roaming events between two different APs from the 5/6 GHz band to the 2.4 GHz band. The right side of FIG. 7B is a scatterplot of example interband roam scores for a plurality of interband roaming events between two different APs from the 2.4 GHz band to the 5/6 GHz band. The thresholds between the scores are those from the tables shown above. However, it shall be understood that different thresholds could be used, and that the disclosure is not limited in this respect.

A comparison of the two scatterplots shows that in general, in this example, more of the interband roaming events between two different APs from the 2.4 GHz band to the 5/6 GHz band (right side of FIG. 7B) are classified as “Good” as compared to the interband roaming events between two different APs from the 5/6 GHz band to the 2.4 GHz band (left side of FIG. 7B)

Possible root causes of average, poor, or worst interband scores include, but are not limited to, too few APs at a site, a coverage hole at the site, or a power imbalance between APs and/or bands at the site. Remedial actions to address a potential coverage hole include adding one or more additional APs to the wireless network and/or adjusting the transmit power balance among one or more of the APs in the wireless network. The remedial actions may also include generating a notification including a suggestion to add one or more additional APs to the wireless network and/or adjust the transmit power balance among one or more of the APs in the wireless network. The remedial action may also include automatically adjusting the transmit power of one or more bands of one or more APs in the wireless network.

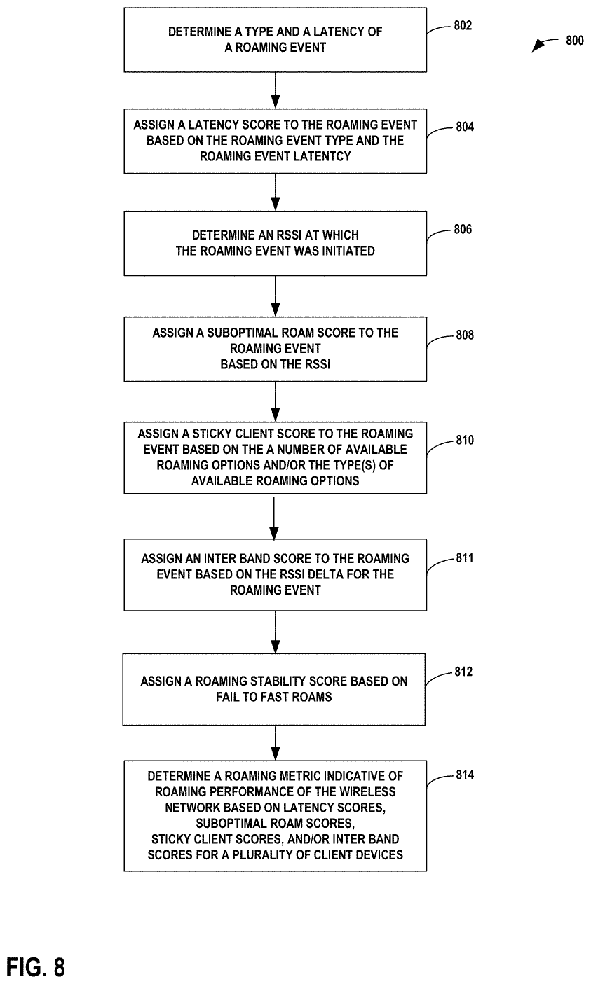

FIG. 8 is a flowchart of an example process (800) by which a network management system determines a roaming metric for a wireless client device in a wireless network in accordance with one or more techniques of the disclosure. The NMS determines a type and a latency (e.g., a duration) of a roaming event (802). The roaming event types may include, for example, standard (slow) roam events, OKC (fast) roam events, and/or 802.11r (fast) roam events. The NMS assigns a latency score to a roaming event based on the latency of the roaming event (804). The NMS determines an RSSI at which the roaming event was initiated (806). For example, the RSSI at which the roaming event was initiated may include a first (or “previous” as shown in FIG. 6C) RSSI of a first wireless signal received by a client device from a first access point (AP) with which the client was associated at the start of the roaming event (i.e., the disassociated AP that was roamed away from) and a second (or “current” as shown in FIG. 6B) RSSI of a second wireless signal received by the client device from a second AP with which the client device is associated after completion of the roaming event (i.e., the re-associated or target AP). The NMS assigns a suboptimal roam score to a roaming event based on the RSSI at which the roaming event was initiated corresponding to the roaming event (808). In some examples, the NMS may further determine a sticky client score based on a number of available roaming options and/or the type(s) of roaming options available to the client device (810). In some examples, the NMS may further determine an interband score based on an RSSI delta (e.g., change in RSSI of the received wireless signal before and after an interband roaming event) experienced by the wireless client device for the roaming event (811). In some examples, NMS may further determine a roaming stability score based on fail to fast roams (812). In some examples, the NMS may further determine a roaming metric based on one or more of latency score(s), suboptimal roam score(s), sticky client score(s), and/or interband score(s) (814). The NMS may continuously repeat process (800) for the wireless network and update the latency scores, suboptimal roaming scores, sticky client scores, interband scores, roaming stability scores, and roaming metric on a continuous basis.

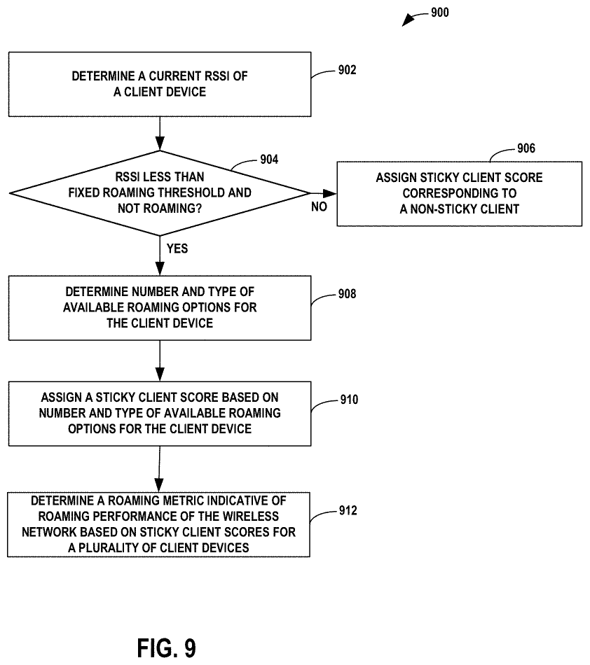

FIG. 9 is a flowchart of an example process (900) by which processing circuitry of a network management system, such as NMS 150 or NMS 300, determines a sticky client score for a client device in a wireless network in accordance with one or more techniques of the disclosure. For purposes of the disclosure, a sticky client is defined as a client device having a current RSSI value of less than the fixed roaming threshold for the client device and having one or more roaming options at least 7 dBm better than the current RSSI value. The NMS determines a current RSSI of the client device (902). The current RSSI of the client device is the RSSI of a wireless signal received from an AP with which the client device is currently associated. The current RSSI is determined from the perspective of the client device.

The NMS determines whether the client device meets the definition of a sticky client. In this example, the NMS determines whether the current RSSI is less than the fixed roaming threshold of the client device and, if so, determines whether the client device has not performed a roaming operation (904). If the client device does not meet the definition of a sticky client (NO branch of 904), the NMS assigns a sticky client score indicative that the client device is not sticky client (906).

If the client device meets the definition of a sticky client (YES branch of 904), the NMS determines the number of roaming options available to the client device and the type of roaming options available to the client device (908). The NMS assigns a sticky client score to a client device based on a number of available roaming options and/or the type of available roaming options for the client device (910). In some examples, the NMS may further determine a roaming metric indicative of roaming performance of the wireless network based on sticky client scores for a plurality of client devices (912). The NMS may continuously repeat process (900) for each client associated with the wireless network and update the sticky client score(s) on a continuous basis.

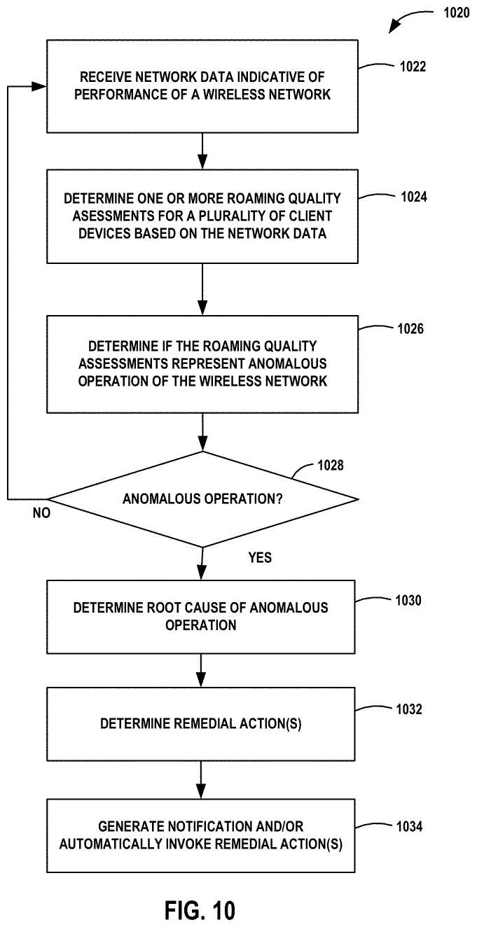

FIG. 10 is a flowchart of an example process (1020) by which a computing device, such as a network management system, such as NMS 150 and/or 300, determines whether one or more roaming quality assessment(s) represent anomalous operation of a wireless network in accordance with one or more techniques of the disclosure. The NMS receives network data indicative of performance of a wireless network (1022). The network data may be obtained or determined by a plurality of client devise in the wireless network, a plurality of APs associated with the wireless network, and/or any other device associated with the wireless network. The NMS determines one or more roaming quality assessments for each roaming event and/or client device based on the network data (1024). For example, the roaming quality assessments may include one or more of a latency score associated with each roaming event, a suboptimal roaming score associated with each roaming event, a sticky client score associated with each roaming event, an interband score associated with each roaming event. In some examples, the roaming quality assessment may also include detection of ping-pong and/or excessive roaming events for one more client devices, which in some examples are considered as anomalous roaming behavior.

The NMS determines if one or more of the roaming quality assessments represent anomalous operation of the wireless network (1026). For example, the NMS may apply a trained machine learning model to classify operation of the wireless network based on historical network data. The trained machine learning model may classify operation of the wireless network as normal or expected operation or as one or more classifications of anomalous operation depending, for example, on which of the roaming quality assessments represent anomalous operation and/or the relative severity of the anomalous operation.

If NMS determines that one or more roaming quality assessments do not represent anomalous operation of the wireless network (e.g., the operation is normal or expected) (NO branch of 1028), the NMS continues to monitor the network data during operation of the wireless network for anomalous operation (1022, 1024, 1026). In some examples, if the NMS determines that the one or more roaming quality assessments represent anomalous operation of the wireless network (YES branch of 1028), the NMS may further determine one or more root causes of the anomalous operation (1030). In some examples, to determine a root cause of the anomalous operation (1030), the processor(s) may refer to root cause association data stored in a database, such as database(s) 312 as shown in FIG. 3A. Root cause association data 60 may include, for example, one or more database structures that associate classification(s) of anomalous operation of with one or more potential root causes. In other examples, to determine a root cause of the anomalous operation (1030), the NMS may invoke a virtual network assistant (VNA), such as VNA engine 350 as shown in FIG. 3A, to invoke a more complex and/or computationally expensive root cause analysis.

The NMS may further determine one or more remedial actions to address the root cause(s) of the anomalous operation (1032). In some examples, to determine a remedial action to address a root cause of the anomalous operation (1032), the NMS may refer to root cause association data stored in database, such as database(s) 312 as shown in FIG. 3A. The root cause association data may include, for example, one or more database structures that associate classification(s) of anomalous operation of with one or more potential root causes, and further that associate each root cause with one or more remedial actions that may be suggested and/or automatically invoked to address the respective root cause. In other examples, to determine remedial action to address a root cause of anomalous operation (532), the processor(s) may invoke a virtual network assistant (VNA), such as VNA 350 as shown in FIG. 3A, to invoke a more complex and/or computationally expensive root cause/remedial action analysis.

The NMS may further generate a notification including an indication of the one or more roaming quality assessments, an indication of any anomalous operation and/or anomalous operation classification, one or more root causes of the anomalous operation, and/or one or more remedial actions to address the root cause(s) of the anomalous operation (1034). In some examples, the NMS may further automatically invoke one or more of the determined remedial actions to address the determined root causes of the anomalous operation of the wireless network (1034). The NMS may continuously repeat process (1020) for the wireless network and update the roaming quality assessments, monitor for anomalous network behavior, determine root cause(s) of anomalous behavior and automatically perform remedial actions to address the anomalous behavior on a continuous basis.

Example techniques for performing a root cause analysis and/or automatic invocation of remedial actions by a network management system are described in U.S. application Ser. No. 14/788,489, filed Jun. 30, 2015, and entitled “Monitoring Wireless Access Point Events,” U.S. application Ser. No. 16/835,757, filed Mar. 31, 2020, and entitled “Network System Fault Resolution Using a Machine Learning Model,” U.S. application Ser. No. 16/279,243, filed Feb. 19, 2019, and entitled “Systems and Methods for a Virtual Network Assistant,” U.S. application Ser. No. 16/237,677, filed Dec. 31, 2018, and entitled “Methods and Apparatus for Facilitating Fault Detection and/or Predictive Fault Detection,” U.S. application Ser. No. 16/251,942, filed Jan. 18, 2019, and entitled “Method for Spatio-Temporal Modeling,” and U.S. application Ser. No. 16/296,902, filed Mar. 8, 2019, and entitled “Method for Conveying AP Error Codes Over BLE Advertisements,” all of which are incorporated herein by reference in their entirety.

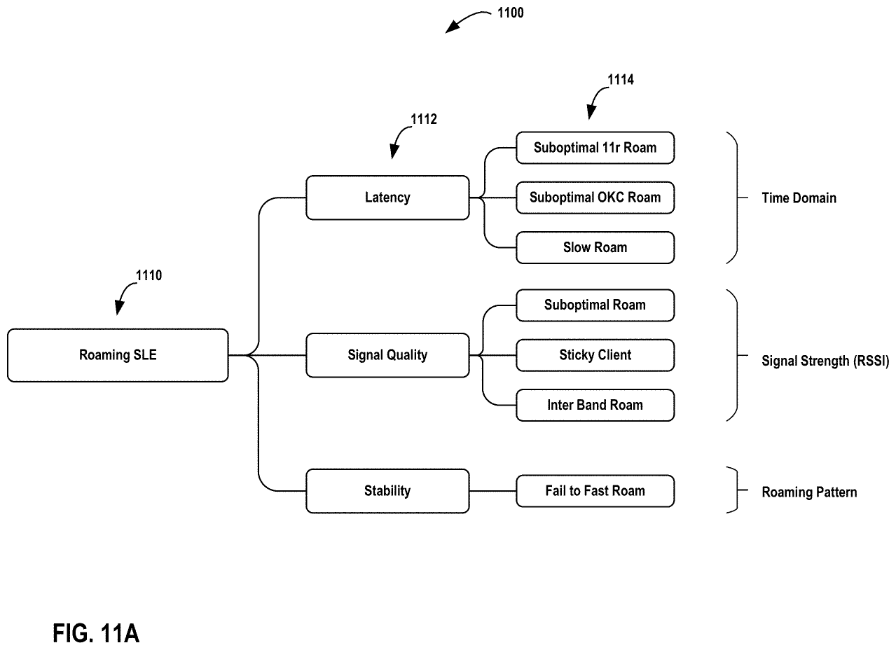

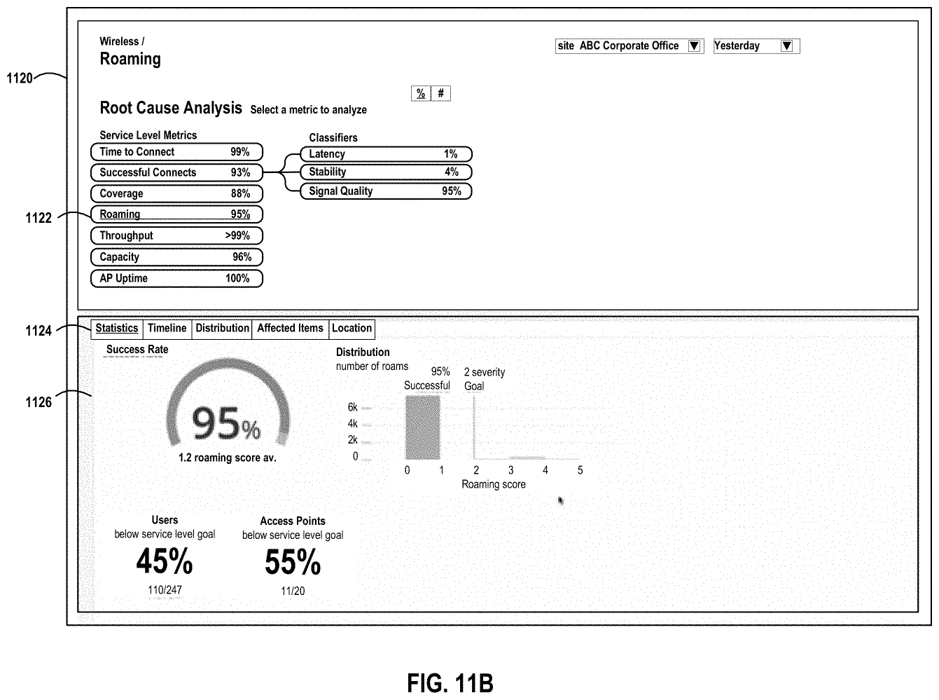

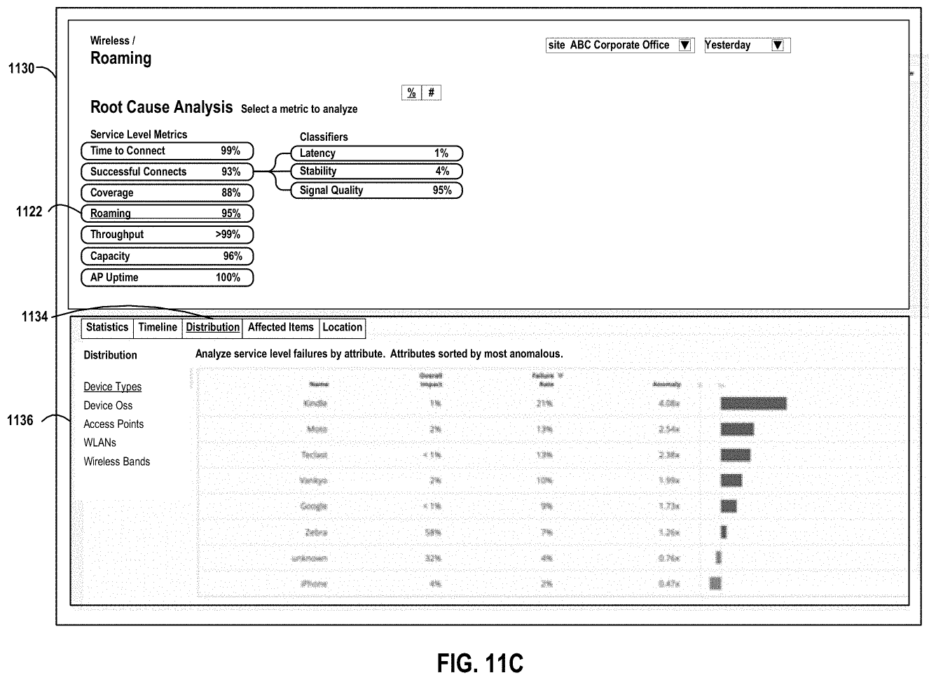

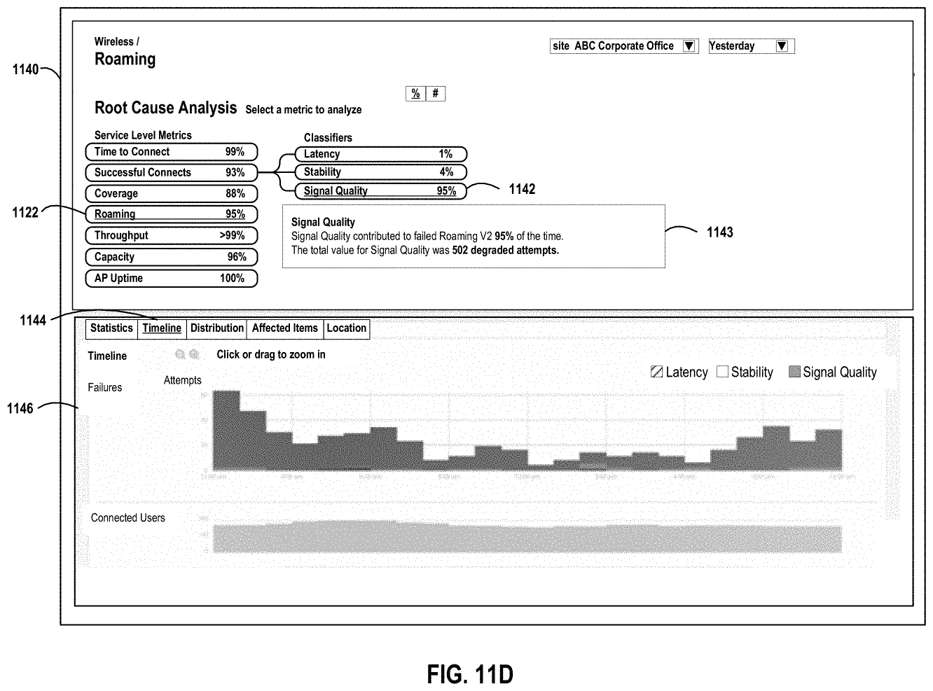

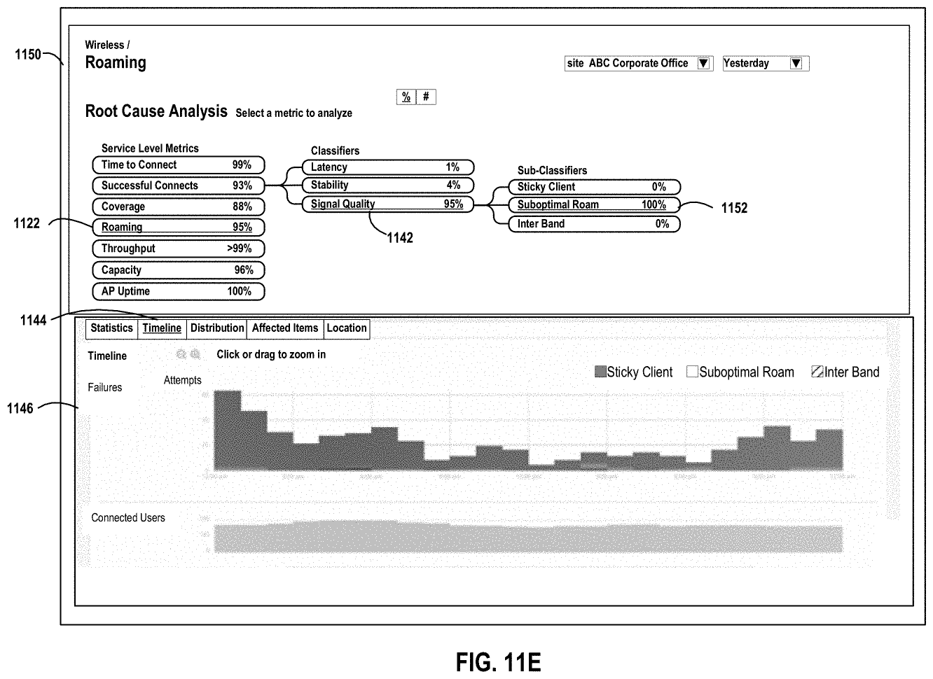

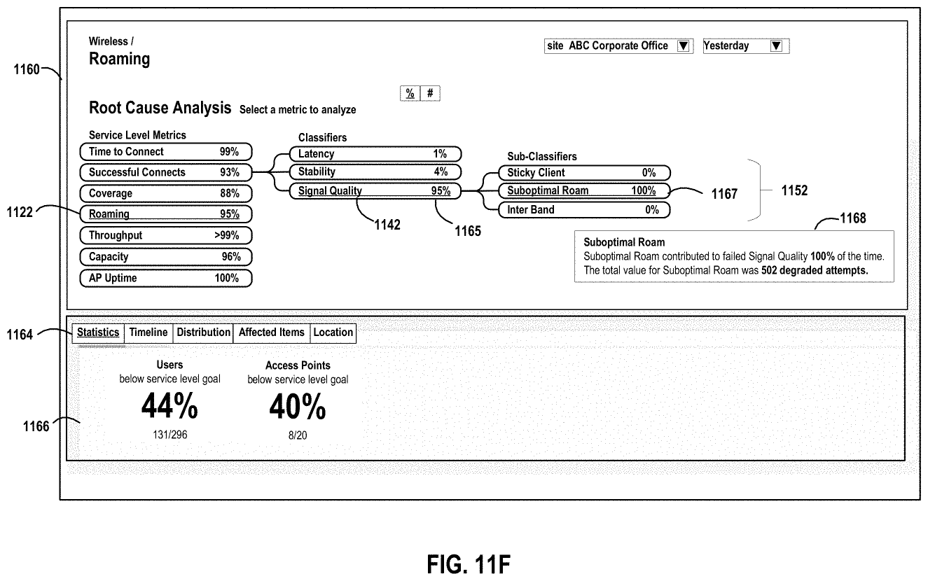

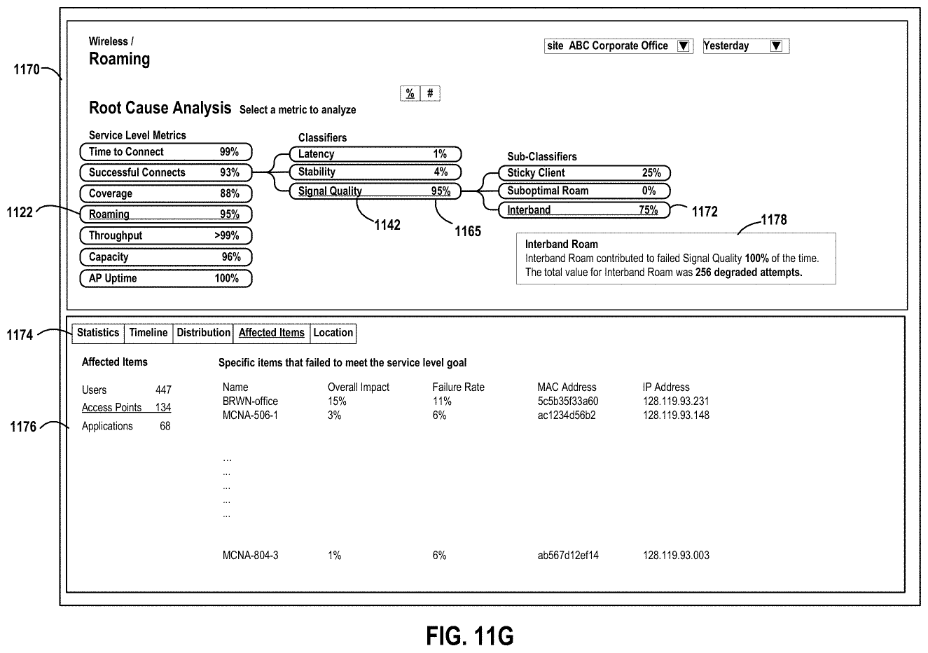

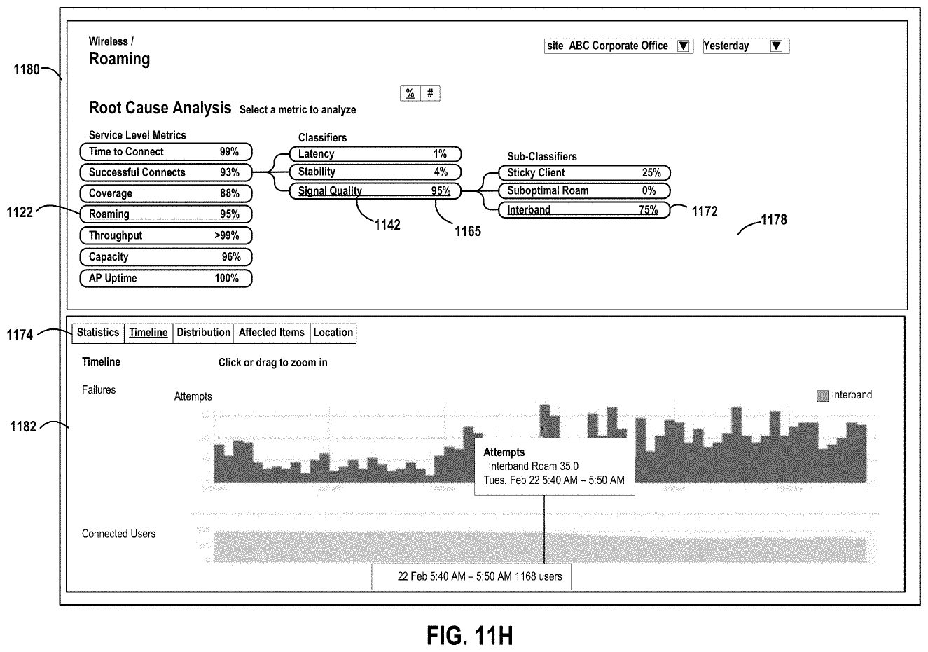

FIGS. 11A-11F are screen shots of example user interfaces generated by one or more processors, such as one or processors of NMS 150/300, including user interface elements representing one or more roaming quality assessments in accordance with one or more techniques of the disclosure. The one or more roaming quality assessments may include, for example, a roaming SLE metric, a roaming latency classifier, a roaming signal quality classifier and/or a roaming stability classifier. The roaming quality assessments may further include one or more roaming latency sub-classifiers, such as a suboptimal 802.11r roam sub-classifiers, a suboptimal OKC roam sub-classifier, and/or a slow roam sub-classifier; one or more signal quality sub-classifiers, such as a suboptimal roam sub-classifier, a sticky client sub-classifier, and/or an interband sub-classifier; and/or one or more stability sub-classifiers, such as a fail to fast roam sub-classifier. Some or all of these example roaming metrics, classifiers, and/or sub-classifiers may be determined by the one or more processors of NMS 150/300 executing roaming metric module 370 of SLE metric module 352 as shown in FIG. 3B.

FIG. 11A shows an example user interface 1100 including user interface elements representing a roaming SLE metric hierarchy 1100. In some examples, NMS 150/300 generates data representative including selectable user interface elements for one or more of a roaming SLE metric 1110, one or more roaming metric classifiers 1112 (e.g., latency, signal quality and stability), and one or more roaming metric sub-classifiers 1114 (e.g., suboptimal 802.11r roam, suboptimal OKC roam, and slow roam, sticky client, interband, and fail to fast roam). The roaming latency classifier scores each roaming event in terms of time and therefore includes time domain-based sub-classifiers such as suboptimal 11r roam, suboptimal OKC roam, and slow roam scores. The roaming signal quality classifier classifies each roaming event in terms of signal strength (e.g., RSSI) and therefore includes RSSI-based and/or roaming type sub-classifiers such as suboptimal roam, sticky client, and interband scores. The stability classifier attempts to score each roaming event to detect certain undesirable roaming patterns, such as fail to fast roam events.

FIGS. 11B-11F show example user interfaces including the example user interface elements 1100 of FIG. 11A. In FIG. 11B, for example, NMS may generate data representative of a user interface 1120 including one or more selectable user interface elements and/or one or more sub-windows including roaming quality assessment information. In this example, user interface 1120 includes selectable user interface element 1122 by which a user may select to view data associated with the roaming quality assessments of the present disclosure. In this example, a user has selected the user interface element 1122 corresponding to a roaming SLE metric, which causes NMS 150/300 to display selectable user interface elements corresponding to roaming assessment classifiers latency, stability, and signal quality. User interface 1120 also includes a sub-window 1126 having one or more user selectable tabs by which a user may view selected roaming assessment information. For example, selection of a “Statistics” tab 1124 as shown in FIG. 11B shows that the roaming success rate for the currently selected time period (“Yesterday” as selected in the top right corner of user interface 1120) was 95%, meaning that 95% of roaming events occurring over the selected time period satisfied the threshold(s) for either a “good” or “excellent” roaming SLE metric. In this example, the average roaming metric score was 1.2 (i.e., between an “excellent” score of 1 and a “good” score of 2).

As another example, as shown in the example of FIG. 11C, selection of a “Distribution” tab 1134 causes NMS 150/300 to display roaming quality assessment information for a plurality of device types. A user may further select any of selectable user interface elements “Device OS”, “Access Points”, “WLANs” or “Wireless Bands” to display roaming quality assessment data (e.g., percentage of service level failures) corresponding to each of those attributes.

As another example, as shown in the example of FIG. 11D, selection of the “Timeline” tab 1144 causes NMS 150/300 to display a “Timeline” charts in a sub-window 1146. In addition, FIG. 11D further illustrates that selectable user interface element 1142 may be hovered over by a user, causes NMS 150/300 to display a pop-up box 1143 describing further details corresponding to the signal quality classifier.

As shown in the example of FIG. 11E, selection of the selectable user interface element 1142 for the signal quality classifier causes NMS 150/300 to generate a user interface 1150 including selectable user interface elements 1152 for the associated sub-classifiers sticky client, interband, and suboptimal roam.

As shown in the example of FIG. 11F, a selectable user interface element 1167 may be hovered over by a user, causing NMS 150/300 to display a pop-up box 1168 describing further details corresponding to the suboptimal roam sub-classifier for the signal quality classifier. In general, each selectable user interface element corresponding to the roaming SLE metric (e.g., user interface element 1122), one of the roaming quality classifiers (e.g., user interface element 1142) and/or one of the roaming quality sub-classifiers (e.g., user interface element 1152) includes a percentage value (in this example, 1161, 1165 and 1167, respectively). In some examples, NMS 150/300 executes VNA/AI engine 350 and root cause analysis module 354 to determine how to attribute roaming event failures among the roaming assessment classifiers and sub-classifiers. For example, NMS 150/300 may execute one or more steps of example process (1020) as shown in FIG. 10 to determine the root cause of roaming event failures and/or attribute roaming event failures among the roaming assessment classifiers and sub-classifiers.

In the example of FIG. 11F, for the roaming SLE metric 1122, user interface element 1161 indicates that 95% of the roaming events for the selected time period satisfied the roaming thresholds set for the site. The user interface elements for roaming classifiers latency, stability and signal quality include percentages of 1%, 4% and 95%, respectively. These values mean that, of the 5% of roaming events that did not satisfy the roaming thresholds, 1% of those could be attributed to latency issues, 4% could be attributed to stability issues, and 95% could be attributed to signal quality issues. In addition, 100% of the signal quality issues could be attributed to suboptimal roams in this example, as indicated by reference numeral 1167.

As shown in the example of FIG. 11G, a user interface 1170 includes a selectable user interface element 1172 corresponding to the interband sub-classifier. User interface element 1172 may be hovered over by a user, causing NMS 150/300 to display a pop-up box 1178 describing further details corresponding to the interband sub-classifier for the signal quality classifier. In the example of FIG. 11G, 25% of the signal quality issues could be attributed to the sticky client sub-classifier and 75% could be attributed to the interband sub-classifier.

Sub-window 1176 displays data and statistics corresponding to the “Affected Items” tab for the interband sub-classifier. In this example, “Access Points” has been selected, causing sub-window 1176 to display a list of access points that failed to meet the service level goal (e.g., an interband score of average, poor or worst). Details concerning each affected AP, including the name, overall impact, failure rate, MAC address and IP address are also listed to provide guidance to IT personnel when diagnosing and addressing failures.

In the example of FIG. 11H, the “Timeline” tab has been selected, causing sub-window 1182 to display a timeline of attempted interband roams. User may hover over or select a particular time (in this example, Tues, February 22 5:40 AM—5:50 AM has been selected) to view more specific information for the selected time or time period.

In some examples, NMS 140/300 may detect ping-pong roaming events for one or more client devices associated with a wireless network, in accordance with one or more techniques of the disclosure. For purposes of the present disclosure, a “ping-pong roaming event” describes a sequence of two or more successive roaming events that satisfy one or more predetermined criteria, as described herein below.

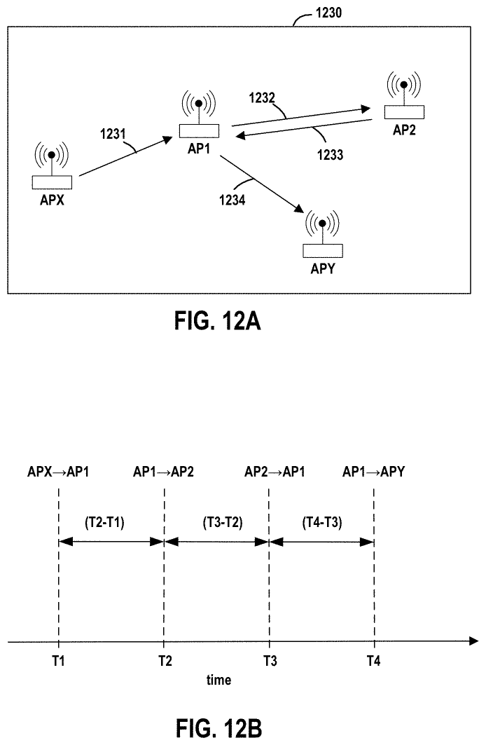

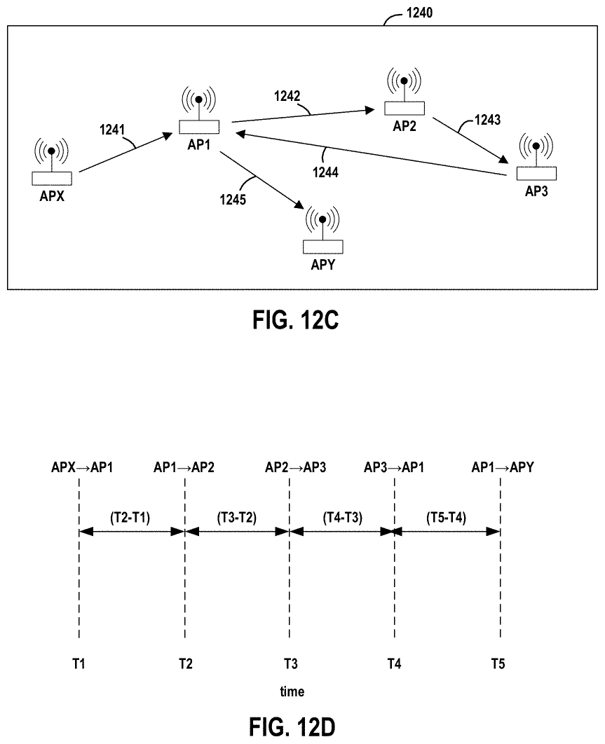

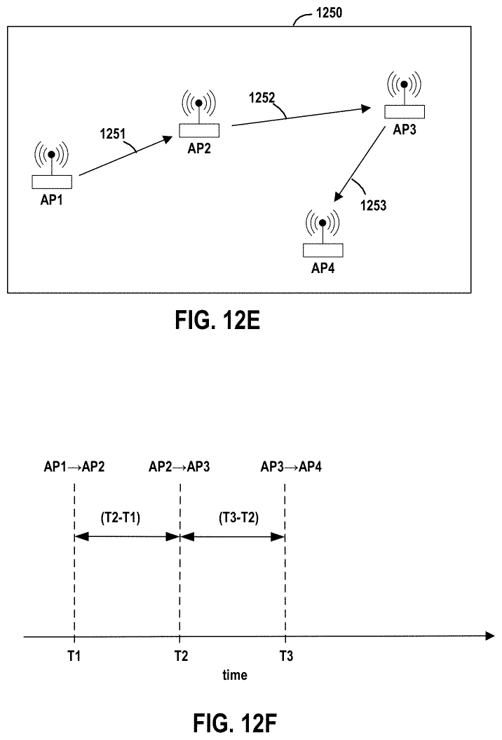

FIG. 12A illustrates an example ping-pong roaming scenarios of a wireless client device that may be detected by an NMS, such as NMS 150 and/or 300, in accordance with one or more techniques of the disclosure. In some examples, a ping-pong roaming event is detected when a client device executes two or more successive roaming events between a set of APs, wherein a time difference between each successive roaming event occurs within a predetermined time period. The set of APs may include, for example, a set of two APs, a set of three APs, or a set of more than three APs. In other examples, a ping-pong roaming event is detected when a client device executes two more successive roaming events between two or more bands of a single AP within a predetermined period of time.

FIG. 12A illustrates an example ping-pong roaming scenario 1230 during which a client device (not shown) executes a sequence of successive roaming events between four APs, i.e., APX, AP1, AP2, and APY. In FIG. 12A, the “ping-pong roaming event” is comprised of two roaming events 1232 and 1233 between a set of two APs, i.e., AP1 and AP2.

Assume a client device (not shown) is associated with the first AP, i.e., APX. The client device executes a first roaming event as indicated by arrow 1231, during which the client device roams from APX to AP1. APX is thus the “previous” AP for roaming event 1231 and AP1 is the “target” AP for roaming event 1231. At a subsequent time, the client device executes a second successive roaming event as indicated by arrow 1232, during which the client device roams from AP1 to AP2 (AP1 is the previous AP and AP2 is the target AP for roaming event 1232). At a subsequent time, the client device executes a third successive roaming event as indicated by arrow 1233, during which the client device roams from AP2 back to AP1 (AP2 is the previous AP and AP1 is the target AP for roaming event 1233). The client device then executes a fourth successive roaming event 1234, during which the client device roams from AP1 to APY (AP1 being the previous AP and APY being the target AP for roaming event 1234).

FIG. 12B shows a timing diagram for the roaming events of FIG. 12A. At time T1, the client device executes the first roaming event 1231 from APX to AP1. At time T2, the client device executes the second successive roaming event 1232 from AP1 to AP2. At time T3, the client device executes the third successive roaming event 1233 from AP2 back to AP1 At time T4, the client device executes the fourth successive roaming event 1234 from AP1 to APY.

The computing device determines a time difference between execution of each successive roaming event. For example, as shown in FIG. 12B, the computing device determines a time difference between execution of roaming event 1231 and 1232 (T2-T1), a time between execution of roaming events 1232 and 1233 (T3-T2), and a time between execution of roaming events 1233 and 1234 (T4-T3). The time differences (T2-T1), (T3-T2) and (T4-T3) may thus be considered an effective “dwell time” that the client device was associated with AP1 (after completion of first roaming event 1231), AP2, and AP1 (after completion of roaming event 1234), respectively.

To detect a ping-pong roaming event such as that shown in the example of FIGS. 12A-12B, a computing device, such as NMS 150/300, determines whether a time difference between two successive roaming events executed by a client device satisfies a predetermined time period. Specifically, the computing device determines whether the time difference between two successive roaming events (in this example, roaming events 1232 and 1233) executed by a client device satisfy a predetermined time period. In addition, the computing device also determines whether a previous AP (AP1) for a first roaming event (1232) of the two successive roaming events matches a target AP (AP1) for a second roaming event (1233) of the two successive roaming events. If both of these criteria are satisfied, the computing device determines that the combination of roaming events 1232 and 1233 qualify as a ping-pong roaming event.

The predetermined period of time may be configurable based on one or more factors including, but not limited to, the type of ping-pong roaming event (e.g., the total number of individual roaming events and/or APs in a ping-pong roaming event), the type of roam (e.g., slow roam, fast roam (802.11r), Opportunistic Key Caching (OKC) roam, interband roam, etc.), the site at which the APs are deployed to provide the wireless network, the location of the client device, the roaming behavior of the client device, the type of client device, or based on any other factor, and the disclosure is not limited in this respect. In some examples, the predetermined period of time may be in a range of 0-60 seconds. However, other ranges for the predetermined period of time may also be used, and the disclosure is not limited in this respect.

FIGS. 12C-12D illustrate another example ping-pong roaming scenario 1240 during which a client device (not shown) executes a sequence of successive roaming events between five APs, i.e., APX, AP1, AP2, AP3, and APY. For example, assume a client device is associated with APX. At a first time, T1, the client device executes a first roaming event as indicated by arrow 1241, during which the client device roams from APX to AP1. At a subsequent time, T2, the client device executes a second successive roaming event as indicated by arrow 1242, during which the client device roams from AP1 to AP2. At a subsequent time, T3, the client device executes a third successive roaming event as indicated by arrow 1243, during which the client device roams from AP2 to AP3. At a subsequent time, T4, the client device executes a fourth successive roaming event as indicated by arrow 1244, during which the client device roams from AP3 back to AP1. At a subsequent time, T5, the client device executes a fifth successive roaming event 1245, during which the client device roams from AP1 to APY.

The computing device determines a time difference between execution of each successive roaming event. For example, as shown in FIG. 12D, the computing device determines a time difference between execution of roaming event 1241 and 1242 (T2-T1), a time between execution of roaming events 1242 and 1243 (T3-T2), a time between execution of roaming events 1243 and 1244 (T4-T3), and a time between execution of roaming events 1244 and 1245 (T-T4). The time differences (T2-T1), (T3-T2), (T4-T3), and (T5-T4) may thus be considered an effective “dwell time” that the client device was associated with AP1 (after completion of roaming event 1241), AP2, AP3, and AP1 (after completion of roaming event 1245), respectively.

To detect a ping-pong roaming event such as that shown in the example of FIGS. 12C-12D, a computing device, such as NMS 150/300, determines whether a time difference between each of at least three successive roaming events executed by a client device satisfies a predetermined time period. Specifically, the computing device determines whether the time difference between each of three successive roaming events (in this example, (T3-T2) and (T4-T3)) executed by a client device satisfy a predetermined time period. In addition, the computing device further determines whether a previous AP for a first roaming event of the three successive roaming events matches a target AP for a third roaming event of the three successive roaming events. In other words, the client device completes a loop between the three or more APs. In the example of FIGS. 12C-12D, the computing device determines whether a client device executes three successive roaming events (e.g., 1242, 1243, and 1244) for which a current AP (AP1) for a first roaming event (1242) of the three successive roaming events matches a target AP (also AP1) for a third roaming event (1244) of the three successive roaming events. Although FIGS. 12C and 12D show a ping-pong roaming event between three APs, other ping-pong roaming events may be defined with three or more APs, and the disclosure is not limited in this respect.

In addition to detecting whether there is a previous/target AP match for the first and third roaming events of the sequence of roaming events (or the first and nth roaming events of n successive roaming events in the general case), the computing device may further apply additional criteria as described above with respect to FIG. 12C to the sequence of three successive roaming events to detect a ping-pong roaming event. For example, the computing device may determine whether each of the successive roaming events were executed within the predetermined time period of the immediately preceding roaming event in the sequence of roaming events. Thus, time periods (T3-T2), (T4-T3) and (T5-T4) must each satisfy the predetermined period of time in order for the combination of roaming events 1242, 1243 and 1244 to qualify as a ping-pong roaming event in this example. As discussed above, the predetermined period of time may be configurable based on one or more factors. In some examples, the predetermined period of time may be in a range of 0-60 seconds. However, other ranges for the predetermined period of time may also be used, and the disclosure is not limited in this respect.

Different criteria for different types of roaming events may be defined. For example, a number of APs, m, wherein each integer value of m corresponds to a different type of ping-pong roaming event, may be defined. Different ping-pong roaming criteria may be defined for different integer values of m. For example, different predetermined time periods may be applied for different values of m. In addition, the number of roaming events required to qualify as a ping-pong roaming event may also be configurable. In FIG. 12A, for example, a ping-pong roaming event may be detected when the time difference between two successive roaming events, 1232 and 1233, satisfies the predetermined time period. In other examples, three or more successive roaming events between AP1 and AP2 may be required (that is, the client device may continue to roam back and forth multiple times between AP1 and AP2), each of which satisfies the predetermined time period with respect to the immediately preceding roaming event, in order to qualify as a ping-pong roaming event.

The examples of FIGS. 12A-12D illustrate ping-pong roaming events between two or more different APs. In other examples, a computing device may also detect ping-pong roaming events that occur between two different bands of a single AP. Tor example, rather than detecting a ping-pong roaming event between two different APs (such as shown in FIGS. 12A-12B), a ping-pong roaming event between two different bands of a single AP (e.g., roaming back and forth between the 2.4 GHz and the 5 GHz bands of a single AP) may be detected using the similar timing criteria as those discussed above. As another example, in addition to detecting a ping-pong roaming event between three different APs (such as shown in FIGS. 12C-12D), a ping-pong roaming event may be detected between two different bands of a first AP and one band of a second AP, and/or three different bands of a single AP (e.g., roaming between the 2.4 GHz, 5GHz and 6 GHz bands of a single AP). Thus, although examples of ping-pong roaming events between different APs are shown in FIGS. 12A-12D, any of the ping-pong roaming events described herein may also include at least one individual roaming event between two different bands of a single AP, and the disclosure is not limited in this respect.

In some examples, NMS 150/300 detects one or more types of excessive roaming events for one or more client devices associated with a wireless network, in accordance with one or more techniques of the disclosure. For purposes of the disclosure, the term “excessive roaming event” describes a combination of two or more roaming events that satisfy one or more predetermined criteria, as described herein below. For example, a computing device may detect an excessive roaming event when a client device executes a sequence of three or more successive roaming events, each within a predetermined time period. For excessive roaming events, the successive roaming events are not executed within the same set of APs as with ping-pong roaming events.

FIGS. 12E-12F illustrate an example excessive roaming scenario 1250 during which a client device (not shown) executes a sequence of successive roaming events between a set of four APs, i.e., AP1, AP2, AP3, and AP4, each within a predetermined period of time. In FIG. 12E, the “excessive roaming event” is comprised of three roaming events 1251, 1252 and 1253.

Assume a client device (not shown) is associated with the first AP, i.e., AP1. At a first time, T1, the client device executes a first roaming event as indicated by arrow 1251, during which the client device roams from AP1 to AP2. At a subsequent time, T2, the client device executes a second successive roaming event as indicated by arrow 1252, during which the client device roams from AP2 to AP3. At a subsequent time, T3, the client device executes a third successive roaming event as indicated by arrow 1253, during which the client device roams from AP3 to AP4.

The computing device determines a time difference between execution of each successive roaming event. For example, as shown in FIG. 12F, the computing device determines a time difference between execution of roaming event 1251 and 1252 (T2-T1), and a time between execution of roaming events 1252 and 1253 (T3-T2). The time differences (T2-T1) and (T3-T2) may thus be considered an effective “dwell time” that the client device was associated with AP2 and AP3, respectively.

To detect an excessive roaming event, a computing device, such as NMS 150/300, determines whether a time difference between two successive roaming events in a sequence of at least n roaming events executed by a client device satisfies a predetermined time period. Specifically, to detect an excessive roaming event with respect to the example of FIG. 12E-12F, a computing device determines whether the time difference between two successive roaming events in a sequence of at least three roaming events (in this example, (T2-T1) and (T3-T2)) executed by a client device satisfy a predetermined time period.

The predetermined period of time for detection of excessive roaming events may be configurable based on one or more factors as discussed above with respect to ping-pong roaming events. In some examples, the predetermined period of time may be in a range of 0-60 seconds. However, other ranges for the predetermined period of time for detection of excessive roaming events may also be used, and the disclosure is not limited in this respect.

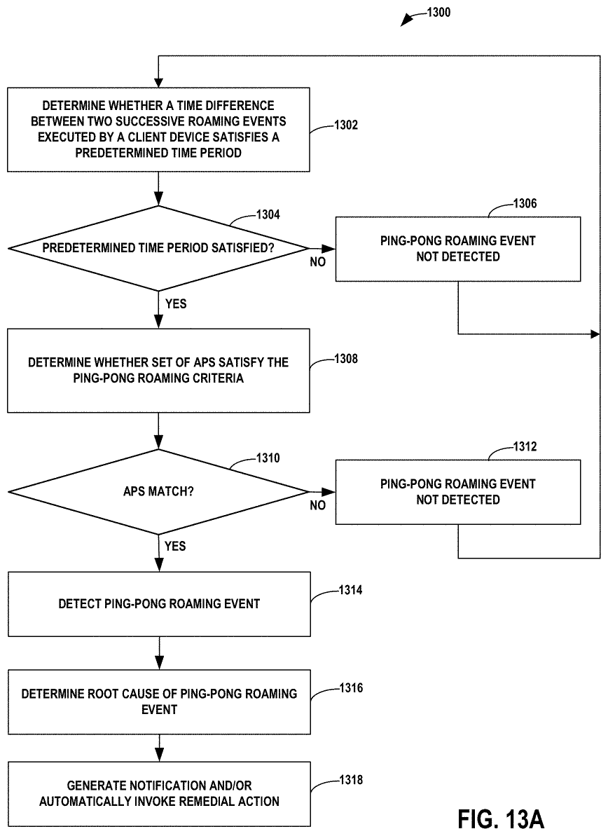

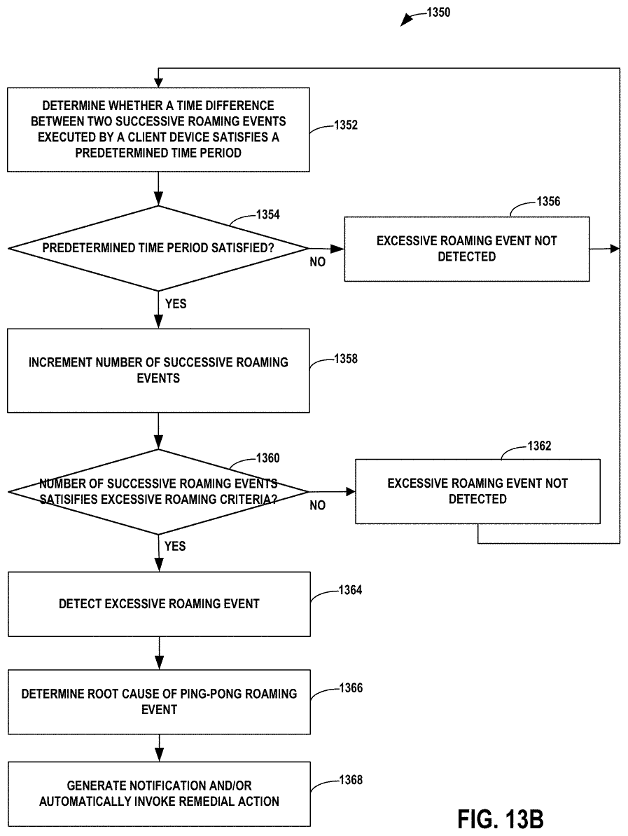

FIG. 13A is a flowchart of an example process (1300) by which a computing device, such as a network management system (e.g., NMS 150/300), detects a ping-pong roaming event in accordance with one or more techniques of the disclosure. The computing device determines whether a time difference between two successive roaming events executed by a client device satisfies a predetermined time period (1302). For example, the computing device determines whether a time difference between execution of first roaming event by a client device and execution of a second, immediately succeeding roaming event by the client device satisfies a predetermined time period (1302). If the predetermined time period is not satisfied (NO branch of 1304), the computing device determines that the sequence of two successive roaming events do not qualify as a ping-pong roaming event (1306).

In some examples, the computing device detects a ping-pong roaming event upon determining a time difference between two successive roaming events executed by a client device satisfies the predetermined time period (1302). The combination of roaming events 1232 and 1233 in FIG. 12A would qualify as a ping-pong roaming event in such examples. In other examples, a ping-pong roaming event is defined as a sequence of n successive roaming events between the same two APs, each of which satisfies the predetermined time period with respect to the immediately preceding roaming event. For example, referring again to FIG. 12A, rather than detecting a ping-pong roaming event upon determining the time difference between two successive roaming events (1232 and 1233) satisfies the predetermined time period, the computing device may require that the client device executes a sequence of n successive roaming events between AP1 and AP2, each of which satisfies the predetermined time period with respect to the immediately preceding roaming event, in order for the sequence of n roaming events to qualify as a ping-pong roaming event. The number n is an integer number and may be configurable based on various factors including, but not limited to, client roaming behavior, the type of client device (e.g., mobile computing devices such as smart phones versus robotic automation for e-commerce applications, etc.), the type of roaming (e.g., slow roam, fast roam, OKC roam, interband roam, etc.), the site, or on any other basis, and the disclosure is not limited in this respect.

If the predetermined time period is satisfied (and/or a sequence of n successive roaming events satisfying the predetermined time period has been detected) (YES branch of 1304), the computing device determines whether a set of m APs corresponding to the two (or more) successive roaming events satisfy one or more ping-pong roaming event criteria (1308). For example, if the sequence of n successive roaming events includes two roaming events, such as roaming events 1232 and 1233 of FIG. 12A, the set of m APs includes two APs, i.e., AP1 and AP2. In such examples, the roaming criteria may include determining whether a previous AP for a first roaming event (e.g., AP1 of roaming event 1232) of the two successive roaming events matches a target AP for a second, immediately succeeding roaming event (e.g., AP1 of roaming event 1233) of the two successive roaming events. In some examples, the roaming criteria may also include determining whether the target AP for the first roaming event (e.g., AP2 of roaming event 1232) matches a previous AP for the second, immediately succeeding roaming event (e.g., AP2 of roaming event 1233). As another example, if the sequence of successive roaming events includes three roaming events, such as roaming events 1242, 1243, and 1244 of FIG. 12C, the set of m APs includes three APs, i.e., AP1, AP2, and AP3. The computing device determines whether a previous AP for a first roaming event of the three successive roaming events matches a target AP for a third roaming event of the three successive roaming events. Ping-pong roaming events may also be defined for three or more APs, including different roaming patterns between the three or more APs (e.g., a loop including roaming events 1242, 1243, and 1244 is shown in FIG. 12C, however, a loop of three successive roams between the three APs, i.e., AP1, AP2, and AP3, need not necessarily be required) and the disclosure is not limited in this respect.

If the set of APs satisfy the ping-pong roaming event criteria (YES branch of 1310), the computing device determines that the two or more successive roaming events qualify as a ping-pong roaming event (1314). If the set of APs do not satisfy the ping-pong roaming event criteria (NO branch of 1310), the computing device determines that the two or more successive roaming events do not qualify as a ping-pong roaming event (1312).

In some examples, NMS may apply a trained machine learning model to classify a sequence of successive roaming events as a ping-pong roaming event. One or more features of the sequence of roaming events (e.g., a number of individual roaming events in the sequence, the amount of time associated with each roaming event, the type of roaming events (e.g., fast roams, slow roams, OKC roams, interband roams, the set(s) of APs, the number of APs, the type of client device, etc.) may be applied as inputs to the machine learning model in order to determine whether to classify a sequence of successive roaming events as a ping-pong roaming event.

The NMS may further determine one or more root causes of one or more ping-pong roaming event(s) (1316). In some examples, to determine a root cause of the ping-pong roaming event(s) (1316), the processor(s) may refer to root cause association data stored in a database, such as database(s) 312 as shown in FIG. 3A. Root cause association data may include, for example, one or more database structures that associate classification(s) of ping-pong roaming events with one or more potential root causes. In other examples, to determine a root cause of the ping-pong roaming event(s), the NMS may invoke a virtual network assistant (VNA), such as VNA engine 350 as shown in FIG. 3A, to invoke a more complex and/or computationally expensive root cause analysis.

The NMS may further determine one or more remedial actions to address the root cause(s) of the ping-pong roaming event(s) (1318). In some examples, to determine a remedial action (1318), the NMS may refer to root cause association data stored in database, such as database(s) 312 as shown in FIG. 3A. The root cause association data may include, for example, one or more database structures that associate ping-pong roaming events with one or more potential root causes, and further that associate each root cause with one or more remedial actions that may be suggested and/or automatically invoked to address the respective root cause. In other examples, to determine remedial action(s) to address a root cause of ping-pong roaming event(s) (1318), the processor(s) may invoke a virtual network assistant (VNA), such as VNA 350 as shown in FIG. 3A, to invoke a more complex and/or computationally expensive root cause/remedial action analysis.

The NMS may further generate a notification including an indication of any detected ping-pong roaming events, an indication of the client devices and/or the APs involved in any detected ping-pong roaming events, one or more root causes of the detected ping-pong roaming events, and/or one or more suggested remedial actions that may be taken to address the root cause(s) (1318). In some examples, the NMS may further automatically invoke one or more of the determined remedial actions to address the determined root causes of the anomalous operation of the wireless network (1324). The NMS may continuously repeat process (1300) for the wireless network to detect ping-pong roaming events, determine the root cause(s) thereof, generate notifications and/or and automatically perform remedial actions on a continuous, periodic, or scheduled basis.

FIG. 13B is a flowchart of an example process (1350) by which a computing device, such as a network management system (e.g., NMS 150/300), detects an excessive roaming event in accordance with one or more techniques of the disclosure. The computing device determines whether a time difference between two successive roaming events executed by a client device satisfies a predetermined time period (1352). For example, the computing device determines whether a time difference between execution of a first roaming event by a client device and execution of a second, immediately succeeding roaming event by the client device satisfies a predetermined time period (1352). If the predetermined time period is not satisfied (NO branch of 1354), the computing device determines that the sequence of two successive roaming events do not qualify as an excessive roaming event (1356).

In some examples, an excessive roaming event is defined as a sequence of n successive roaming events, each of which satisfies a predetermined time period with respect to the immediately preceding roaming event in the sequence of roaming events. For example, FIG. 12E illustrates a sequence of n=3 roaming events including roaming events 1251, 1252, and 1253. The number n is an integer number and may be configurable based on various factors including, but not limited to, client roaming behavior, the type of client device (e.g., mobile computing devices such as smart phones versus robotic automation for e-commerce applications, etc.), the type of roaming (e.g., slow roam, fast roam, OKC roams, interband roam, etc.), the site, or on any other basis, and the disclosure is not limited in this respect.

If the predetermined time period is satisfied (YES branch of 1354), the computing device increments a number of successive roaming events detected that satisfy the predetermined time period (1358). The computing device determines whether the number of successive roaming events satisfying the predetermined time period satisfies one or more excessive roaming criteria (1360). For example, the excessive roaming criteria may define the number, n, of successive roaming events satisfying the predetermined time period required to qualify as an excessive roaming event.

If the excessive roaming criteria are satisfied (YES branch of 1360), the computing device determines that the n successive roaming events qualify as an excessive roaming event (1364). If the excessive roaming criteria are not satisfied (NO branch of 1360), the computing device determines that the sequence of successive roaming events detected thus far do not qualify as an excessive roaming event (1362). In such examples, the computing device repeats steps (1352, 1354, 1358, 1360) until either two successive roaming events are detected that do not satisfy the predetermined time period (NO branch of 1354) or n successive roaming events satisfying the predetermined time period are detected (YES branch of 1360).

In some examples, the NMS may apply a trained machine learning model to classify a sequence of successive roaming events as an excessive roaming event. One or more features of the sequence of roaming events (e.g., a number of individual roaming events in the sequence, the amount of time associated with each roaming event, the type of roaming events (e.g., fast roams, slow roams, OKC roams, interband roams, etc.), the set(s) of APs, the number of APs, the type of client device, etc.) may be applied as inputs to the machine learning model in order to determine whether to classify a sequence of successive roaming events as an excessive roaming event.

The NMS may further determine one or more root causes of one or more excessive roaming event(s) (1366). In some examples, to determine a root cause of the excessive roaming event(s) (1366), the processor(s) may refer to root cause association data stored in a database, such as database(s) 312 as shown in FIG. 3A. Root cause association data may include, for example, one or more database structures that associate classification(s) of excessive roaming events with one or more potential root causes. In other examples, to determine a root cause of the excessive roaming event(s), the NMS may invoke a virtual network assistant (VNA), such as VNA engine 350 as shown in FIG. 3A, to invoke a more complex and/or computationally expensive root cause analysis.

The NMS may further determine one or more remedial actions to address the root cause(s) of the excessive roaming event(s) (1368). In some examples, to determine a remedial action (1368), the NMS may refer to root cause association data stored in database, such as database(s) 312 as shown in FIG. 3A. The root cause association data may include, for example, one or more database structures that associate excessive roaming events with one or more potential root causes, and further that associate each root cause with one or more remedial actions that may be suggested and/or automatically invoked to address the respective root cause. In other examples, to determine remedial action(s) to address a root cause of excessive roaming event(s) (1368), the processor(s) may invoke a virtual network assistant (VNA), such as VNA 350 as shown in FIG. 3A, to invoke a more complex and/or computationally expensive root cause/remedial action analysis.

The NMS may further generate a notification including an indication of any detected excessive roaming events, an indication of the client devices and/or the APs involved in any detected excessive roaming events, one or more root causes of the detected excessive roaming events, and/or one or more suggested remedial actions that may be taken to address the root cause(s) (1368). In some examples, the NMS may further automatically invoke one or more of the determined remedial actions to address the determined root causes of the anomalous operation of the wireless network (1368). The NMS may continuously repeat process (1350) for the wireless network to detect excessive roaming events, determine the root cause(s) thereof, generate notifications and/or and automatically perform remedial actions on a continuous, periodic, or scheduled basis.

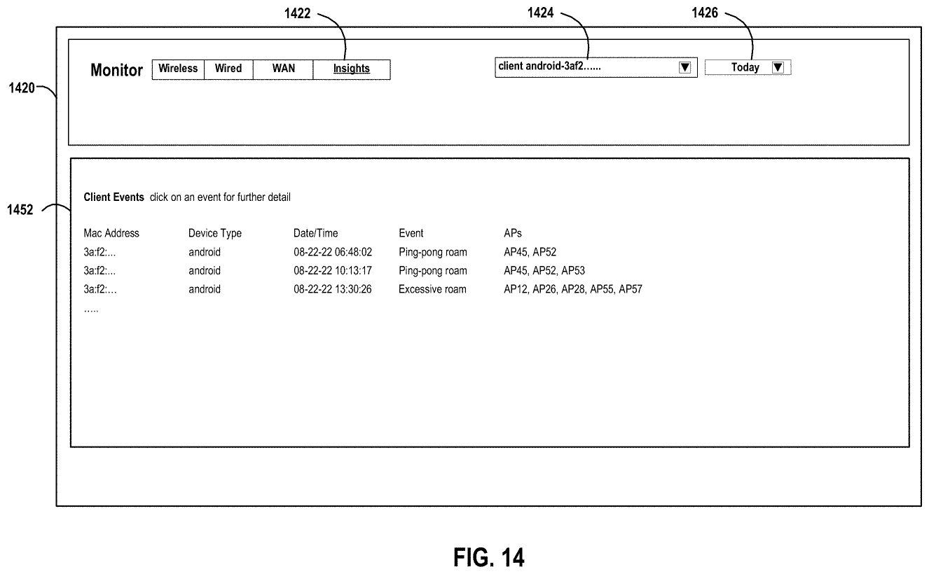

FIG. 14 shows an example user interface 1420 that may be generated by NMS 150/300 including data indicative of one or more ping-pong roaming events or one or more excessive roaming events detected for a client device, in accordance with one or more techniques of the disclosure. In this example, user interface 1420 includes a user selectable interface element 1424 by which a user may select to view data associated with a particular client device. User interface element 1424 includes a drop-down menu by which a user may select one of a plurality of client devices associated with a wired or wireless network. In this example, a user has selected client device “android-3af2 . . .” The user has also selected the time frame “Today” in user interface element 1426 and the “insights” tab 1422, which cause NMS 150/300 to display a subwindow 1452 including an event list corresponding to the selected client device for the selected time frame. Each row of the event list includes one or more details corresponding to a detected event, including, in this example, the MAC address of the selected client device, the device type of the selected client device, a date/time stamp that the event was detected, an event type (in this example, a ping-pong roaming event or an excessive roaming event), and a list of the APs involved in the corresponding ping-pong roaming event or excessive roaming event). In this example, the event list 1452 includes a list of two ping-pong roaming events and one excessive roaming event for the selected client device.

Although a particular user interface displaying ping-pong and/or excessive roaming events is shown, other types of user interfaces or means of displaying data representative of or associated with one or more ping-pong and/or excessive roaming events may also be generated, and the disclosure is not limited in this respect.

The techniques of the disclosure provide one or more technical advantages and practical applications. The techniques enable the NMS 150/300 to automatically monitor and quantify roaming quality, which considers factors other than or in addition to roaming latency (e.g., the amount of time required for a client device to roam from a first AP to a second AP). For example, while roaming latency is a time-based metric, the techniques of the disclosure enable the NMS 150/300 to consider RSSI measurements of wireless signal strength before and after a roaming event when evaluating roaming performance of a wireless network and/or configuring operation of one or more devices in the wireless network (such as one or more APs in the wireless network) to address poor roaming performance. In other examples, the techniques enable the NMS 150/300 to consider the number of roaming options available during each roaming event and/or the types of roaming options available during each roaming event when evaluating performance of the wireless network and/or configuring operation of one or more devices in the wireless network to address poor roaming performance. In other examples, the techniques enable the NMS 150/300 to identify undesirable roaming behaviors, such as fail to fast roam when evaluating performance of the wireless network and/or configuring operation of one or more devices in the wireless network to address poor roaming performance. In other examples, NMS 150/300 may further detect ping-pong and/or excessive roaming events for one or more client devices. In this way, the techniques enable the NMS 150/300 to proactively monitor and analyze roaming events based on one or more factors in addition to or as an alternative to time-based metrics such as roaming latency. Based on the one or more of the roaming quality assessment(s) and/or roaming stability assessments, the NMS 150/300 may further determine a roaming metric indicative of overall roaming performance of the wireless network, identify anomalies in roaming performance of the wireless network, identify a root cause of one or more anomalies in the roaming performance of the wireless network, and/or automatically invoke one or more remedial actions to address the identified anomalies. The remedial actions may include, for example, automatically reconfiguring operation of at least one of the plurality of AP devices 142 in the wireless network. In this way, the performance of the wireless network from the perspective of the client devices, and thus the user experience of the wireless network, may be increased.

The techniques described herein may be implemented using software, hardware and/or a combination of software and hardware. Various examples are directed to apparatus, e.g., mobile nodes, mobile wireless terminals, base stations, e.g., access points, communications system. Various examples are also directed to methods, e.g., method of controlling and/or operating a communications device, e.g., wireless terminals (UEs), base stations, control nodes, access points and/or communications systems. Various examples are also directed to non-transitory machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of example approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

In various examples devices and nodes described herein are implemented using one or more modules to perform the steps corresponding to one or more methods, for example, signal generation, transmitting, processing, and/or receiving steps. Thus, in some examples various features are implemented using modules. Such modules may be implemented using software, hardware or a combination of software and hardware. In some examples each module is implemented as an individual circuit with the device or system including a separate circuit for implementing the function corresponding to each described module. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various examples are directed to a machine-readable medium e.g., a non-transitory computer readable medium, including machine executable instructions for causing a machine, e.g., processor and associated hardware, to perform one or more of the steps of the above-described method(s). Some examples are directed to a device including a processor configured to implement one, multiple, or all of the steps of one or more methods of the one example aspect.

In some examples, the processor or processors, e.g., CPUs, of one or more devices, e.g., communications devices such as wireless terminals (UEs), and/or access nodes, are configured to perform the steps of the methods described as being performed by the devices. The configuration of the processor may be achieved by using one or more modules, e.g., software modules, to control processor configuration and/or by including hardware in the processor, e.g., hardware modules, to perform the recited steps and/or control processor configuration. Accordingly, some but not all examples are directed to a communications device, e.g., user equipment, with a processor which includes a module corresponding to each of the steps of the various described methods performed by the device in which the processor is included. In some but not all examples a communications device includes a module corresponding to each of the steps of the various described methods performed by the device in which the processor is included. The modules may be implemented purely in hardware, e.g., as circuits, or may be implemented using software and/or hardware or a combination of software and hardware.

Some examples are directed to a computer program product comprising a computer-readable medium comprising code for causing a computer, or multiple computers, to implement various functions, steps, acts and/or operations, e.g., one or more steps described above. In some examples, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some examples are directed to a processor configured to implement one or more of the various functions, steps, acts and/or operations of one or more methods described above. Accordingly, some examples are directed to a processor, e.g., CPU, graphical processing unit (GPU), digital signal processing (DSP) unit, etc., configured to implement some or all of the steps of the methods described herein. The processor may be for use in, e.g., a communications device or other device described in the present application.

Numerous additional variations on the methods and apparatus of the various examples described above will be apparent to those skilled in the art in view of the above description. Such variations are to be considered within the scope of this disclosure. The methods and apparatus may be, and in various examples are, used with BLE, LTE, CDMA, orthogonal frequency division multiplexing (OFDM), and/or various other types of communications techniques which may be used to provide wireless communications links between access nodes and mobile nodes. In some examples the access nodes are implemented as base stations which establish communications links with user equipment devices, e.g., mobile nodes, using OFDM and/or CDMA. In various examples the mobile nodes are implemented as notebook computers, personal data assistants (PDAs), or other portable devices including receiver/transmitter circuits and logic and/or routines, for implementing the methods.

In the detailed description, numerous specific details are set forth in order to provide a thorough understanding of some examples. However, it will be understood by persons of ordinary skill in the art that some examples may be practiced without these specific details. In other instances, well-known methods, procedures, components, units and/or circuits have not been described in detail so as not to obscure the discussion.

Some examples may be used in conjunction with various devices and systems, for example, a User Equipment (UE), a Mobile Device (MD), a wireless station (STA), a wireless terminal (WT), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some examples may be used in conjunction with devices and/or networks operating in accordance with existing Wireless-Gigabit-Alliance (WGA) specifications (Wireless Gigabit Alliance, Inc. WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, March 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); IEEE-802.11REVmc (“IEEE 802.11-REVmcTM/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)), IEEE 802.11-2016 and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, or operate using any one or more of the above protocols, and the like.

Some examples may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some examples may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other examples may be used in various other devices, systems and/or networks.

Some demonstrative examples may be used in conjunction with a WLAN (Wireless Local Area Network), e.g., a Wi-Fi network. Other examples may be used in conjunction with any other suitable wireless communication network, for example, a wireless area network, a “piconet”, a WPAN, a WVAN, and the like.

Some examples may be used in conjunction with a wireless communication network communicating over a frequency band of 2.4Ghz, 5 GHz and/or 60 GHz. However, other examples may be implemented utilizing any other suitable wireless communication frequency band(s), for example, an Extremely High Frequency (EHF) band (the millimeter wave (mmWave) frequency band), e.g., a frequency band within the frequency band of between 20 GhH and 300 GHz, a WLAN frequency band, a WPAN frequency band, a frequency band according to the WGA specification, and the like.

While the above provides just some simple examples of the various device configurations, it is to be appreciated that numerous variations and permutations are possible. Moreover, the technology is not limited to any specific channels, but is generally applicable to any frequency range(s)/channel(s). Moreover, and as discussed, the technology may be useful in the unlicensed spectrum.

Although examples are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although examples are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The examples have been described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the examples illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including any communications channel(s)/elements/lines connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the examples described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The examples are described in relation to enhanced communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The example systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

While the above-described flowcharts have been discussed in relation to a particular sequence of events, it should be appreciated that changes to this sequence can occur without materially effecting the operation of the example(s). Additionally, the example techniques illustrated herein are not limited to the specifically illustrated examples but can also be utilized with the other examples and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the examples is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed techniques may be readily implemented in software and/or firmware that can be stored on a storage medium to improve the performance of a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there have at least been provided systems and methods for enhancing and improving conversational user interface. Many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

What is claimed is:

1. A system comprising:
a plurality of access point (AP) devices configured to provide a wireless network at a site; and
a network management system comprising:
a memory storing network data received from the plurality of AP devices, the network data collected by a plurality of client devices associated with the wireless network or the plurality of AP devices; and
one or more processors coupled to the memory and configured to determine, based on the network data, one or more roaming quality assessments for each of a plurality of roaming events in the wireless network, wherein the one or more roaming quality assessments include a suboptimal roam score for each of the plurality of roaming events based on a received signal strength indicator (RSSI) associated with the roaming event.

2. The system of claim 1, wherein the one or more roaming quality assessments further include a sticky client score for each of the plurality of client devices based on a number of roaming options available to the client device and the type of roaming options available to the client device, wherein the sticky client score for each of the plurality of client devices is further based on whether a current RSSI for the client device is less than a fixed roaming threshold associated with the client device.

3. The system of claim 1, wherein the RSSI associated with the roaming event is a first RSSI of a first wireless signal received from a first AP with which the client device is associated before the roaming event.

4. The system of claim 1, wherein the one or more processors are further configured to determine a roaming latency score for each of the plurality of roaming events.

5. The system of claim 4, wherein the processors are further configured to determine a roaming metric indicative of roaming performance of the wireless network based on the roaming quality assessments and the roaming latency score for each of the plurality of roaming events.

6. The system of claim 1, wherein the processors are further configured to identify anomalous operation of the wireless network based on the one or more roaming quality assessments and generate a notification indicative of the anomalous operation of the wireless network and at least one remedial action to address the anomalous operation of the wireless network.

7. The system of claim 6, wherein the processors are further configured to automatically invoke at least one remedial action to address the anomalous operation of the wireless network, wherein the remedial action includes reconfiguring operation of at least one of the plurality of APs in the wireless network.

8. The system of claim 1, wherein the processors are further configured to classify, based on a trained machine learning model and the one or more roaming quality assessments, operation of the wireless network as one of normal operation or anomalous operation.

9. The system of claim 1, wherein the one or more roaming quality assessments further include an interband score for each of the plurality of client devices based on an RSSI delta associated with each of a plurality of interband roaming events.

10. The system of claim 1, further comprising, for least one client device of the plurality of client devices, detecting a ping-pong roaming event including at least two successive roaming events executed by the client device wherein a time difference between execution of a first roaming event of the at least two successive roaming events and execution of a second roaming event of the at least two successive roaming events satisfies a predetermined period of time.

11. The system of claim 1, further comprising, for least one client device of the plurality of client devices, detecting an excessive roaming event including at least three successive roaming events executed by the client device wherein a time difference between execution of a first roaming event of the at least three successive roaming events by the client device and execution of a second roaming event of the at least two successive roaming events by the client device satisfies a predetermined period of time, and wherein a time difference between execution of the second roaming event of the at least three successive roaming events by the client device and execution of a third roaming event of the at least three successive roaming events by the client device satisfies the predetermined period of time.

12. A method comprising:
receiving, by one or more processors of a network management system that manages a plurality of access point (AP) devices associated with a wireless network, network data indicative of performance of the wireless network, the network data collected by a plurality of client devices associated with the wireless network or the plurality of AP devices; and
determining, based on the network data, one or more roaming quality assessments for each of a plurality of roaming events in the wireless network, wherein the one or more roaming quality assessments include a suboptimal roam score for each of the plurality of roaming events based on a received signal strength indicator (RSSI) associated with the roaming event.

13. The method of claim 12, wherein the one or more roaming quality assessments further include a sticky client score for each of the plurality of client devices based on a number of roaming options available to the client device and the type of roaming options available to the client device, wherein the sticky client score for each of the plurality of client devices is further based on whether a current RSSI for the client device is less than a fixed roaming threshold associated with the client device.

14. The method of claim 13, wherein the processors are further configured to determine a roaming metric indicative of roaming performance of the wireless network based on the roaming quality assessments and the sticky client score for each of the plurality of roaming events.

15. The method of claim 12, wherein the processors are further configured to identify anomalous operation of the wireless network based on the one or more roaming quality assessments.

16. The method of claim 12, further comprising at least one of:
generating a notification indicative of the anomalous operation of the wireless network and at least one remedial action to address the anomalous operation of the wireless network; or
automatically invoking at least one remedial action to address the anomalous operation of the wireless network, wherein the remedial action includes reconfiguring operation of at least one of the plurality of APs in the wireless network.

17. The method of claim 12, wherein determining the one or more roaming quality assessments further includes determining an interband score for each of the plurality of client devices based on an RSSI delta associated with each of a plurality of interband roaming events.

18. The method of claim 12, further comprising, for least one client device of the plurality of client devices, detecting a ping-pong roaming event including at least two successive roaming events wherein a time difference between execution of a first roaming event of the at least two successive roaming events by the client device and execution of a second roaming event of the at least two successive roaming events by the client device satisfies a predetermined period of time.

19. A system comprising:
a network management system comprising:
one or more processors; and
at least one memory including instructions that when executed by the one or more processors configure the one or more processors to:
determine, for at least one client device associated with a wireless network including a plurality of access point devices (APs), whether a time difference between a first roaming event and a second roaming event in a sequence of two successive roaming events executed by the client device satisfy a predetermined time period; and
based on a determination that a current AP of the plurality of APs for the first roaming event matches a target AP of the plurality of APs for the second roaming event, detect a ping-pong roaming event.

20. The system of claim 19, wherein the at least one memory including instructions that when executed by the one or more processors configure the one or more processors to:
automatically invoke at least one remedial action to address a root cause of the ping-pong roaming event, wherein the remedial action includes reconfiguring operation of at least one of the plurality of APs in the wireless network.
